(19) United States
(12) Patent Application Publication
(10) Pub. No.: US 2026/0004069 A1
(43) Pub. Date: Jan. 1, 2026

(54) APPARATUSES, METHODS, AND COMPUTER PROGRAM PRODUCTS FOR PROCESSING SERVICE MESSAGE DATA OBJECTS VIA LARGE LANGUAGE MODELING TO PROVIDE SERVICE MESSAGE CLASSIFICATIONS

(71) Applicant: ATLASSIAN PTY, LTD., Sydney (AU)

(72) Inventors: Rutvik Acharya, Vadodara (IN); AbdulMajedRaja RS, Bengaluru (IN); Sarah Williams, Springfield, MO (US); Trevor Townsend, Cedar Park, TX (US); Danielle Kaminski, Oxford (GB)

(21) Appl. No.: 19/248,970

(22) Filed: Jun. 25, 2025

Related U.S. Application Data
(63) Continuation of application No. 18/756,443, filed on Jun. 27, 2024.

(51) Int. Cl. G06F 40/279; G06F 40/30

(52) U.S. Cl. CPC G06F 40/279; G06F 40/30

(57) ABSTRACT

Methods, apparatuses, or computer program products that process service message data objects via large language modeling to provide service message classifications. In some examples, a first large language model is applied to a plurality of service message data objects associated with an application framework to generate a first feature set for the plurality of service message data objects, a plurality of topic data objects representative of respective hierarchical topic classifications for the plurality of service message data objects is generated based on the first feature set, a second feature set is extracted from the plurality of topic data objects, and a second large language model is applied to the second feature set to generate a plurality of theme data objects representative of respective hierarchical theme classifications for the plurality of topic data objects.

### CROSS REFERENCE TO RELATED APPLICATIONS

This application is a continuation of and claims priority to U.S. patent application Ser. No. 18/756,443, titled “APPARATUSES, METHODS, AND COMPUTER PROGRAM PRODUCTS FOR PROCESSING SERVICE MESSAGE DATA OBJECTS VIA UNSUPERVISED MACHINE LEARNING TO PROVIDE SERVICE MESSAGE CLASSIFICATIONS,” and filed Jun. 27, 2024, the entirety of which is hereby incorporated by reference.

### BACKGROUND

It is often difficult to manage and/or support components of a server system in which inputs and/or components of the server system dynamically change. Through applied effort, ingenuity, and innovation, these identified deficiencies and problems have been solved by developing solutions that are configured in accordance with the embodiments of the present disclosure, many examples of which are described in detail herein.

### BRIEF SUMMARY

In an embodiment, an apparatus comprises one or more processors and one or more storage devices storing instructions that are operable, when executed by the one or more processors, to cause the one or more processors to extract a first feature set from a plurality of service message data objects associated with an application framework. In one or more embodiments, the instructions are additionally or alternatively operable, when executed by the one or more processors, to cause the one or more processors to apply an unsupervised natural language processing model to the first feature set to generate a plurality of topic data objects representative of respective hierarchical topic classifications for the plurality of service message data objects. In one or more embodiments, the instructions are additionally or alternatively operable, when executed by the one or more processors, to extract a second feature set from the plurality of topic data objects. In one or more embodiments, the instructions are additionally or alternatively operable, when executed by the one or more processors, to apply a large language model to the second feature set to generate a plurality of theme data objects representative of respective hierarchical theme classifications for the plurality of topic data objects. In one or more embodiments, the respective hierarchical theme classifications are representative of a higher-order hierarchical classification as compared to the respective hierarchical topic classifications. In one or more embodiments, the instructions are additionally or alternatively operable, when executed by the one or more processors, to initiate a rendering of a dashboard visualization via an electronic interface based at least in part on the plurality of theme data objects.

In another embodiment, a computer program product comprises at least one non-transitory computer-readable storage medium having computer-readable program code portions stored therein, where the computer-readable program code portions comprising the executable portion are configured to extract a first feature set from a plurality of service message data objects associated with an application framework. In one or more embodiments, the computer-readable program code portions comprising the executable portion are additionally or alternatively configured to apply an unsupervised natural language processing model to the first feature set to generate a plurality of topic data objects representative of respective hierarchical topic classifications for the plurality of service message data objects. In one or more embodiments, the computer-readable program code portions comprising the executable portion are additionally or alternatively configured to extract a second feature set from the plurality of topic data objects. In one or more embodiments, the computer-readable program code portions comprising the executable portion are additionally or alternatively configured to apply a large language model to the second feature set to generate a plurality of theme data objects representative of respective hierarchical theme classifications for the plurality of topic data objects. In one or more embodiments, the respective hierarchical theme classifications are representative of a higher-order hierarchical classification as compared to the respective hierarchical topic classifications. In one or more embodiments, the computer-readable program code portions comprising the executable portion are additionally or alternatively configured to initiate a rendering of a dashboard visualization via an electronic interface based at least in part on the plurality of theme data objects.

In yet another embodiment, a computer-implemented method comprises extracting a first feature set from a plurality of service message data objects associated with an application framework. In one or more embodiments, the computer-implemented method additionally or alternatively comprises applying an unsupervised natural language processing model to the first feature set to generate a plurality of topic data objects representative of respective hierarchical topic classifications for the plurality of service message data objects. In one or more embodiments, the computer-implemented method additionally or alternatively comprises extracting a second feature set from the plurality of topic data objects. In one or more embodiments, the computer-implemented method additionally or alternatively comprises applying a large language model to the second feature set to generate a plurality of theme data objects representative of respective hierarchical theme classifications for the plurality of topic data objects. In one or more embodiments, the respective hierarchical theme classifications are representative of a higher-order hierarchical classification as compared to the respective hierarchical topic classifications. In one or more embodiments, the computer-implemented method additionally or alternatively comprises initiating a rendering of a dashboard visualization via an electronic interface based at least in part on the plurality of theme data objects.

Various other embodiments are also described in the following detailed description and in the attached claims.

### BRIEF DESCRIPTION OF THE SEVERAL VIEW OF THE DRAWINGS

Having thus described some embodiments in general terms, references will now be made to the accompanying drawings, which are not drawn to scale, and wherein:

FIG. 1 is a block diagram of an example system within which one or more embodiments of the present disclosure may operate;

FIG. 2 is a block diagram of another example system within which one or more embodiments of the present disclosure may operate;

FIG. 3 illustrates an example data flow related to a service message insights apparatus in accordance with one or more embodiments of the present disclosure;

FIG. 4 illustrates another example data flow related to a service message insights apparatus in accordance with one or more embodiments of the present disclosure;

FIG. 5 illustrates another example data flow related to various feature inputs and outputs of various machine learning models in accordance with one or more embodiments of the present disclosure;

FIG. 6 illustrates an example representational hierarchy in accordance with one or more embodiments of the present disclosure;

FIG. 7 illustrates an example dashboard visualization in accordance with one or more embodiments of the present disclosure;

FIG. 8 illustrates another example dashboard visualization in accordance with one or more embodiments of the present disclosure;

FIG. 9 is a flowchart diagram of an example process for generating a dashboard visualization based on one or more theme data objects in accordance with one or more embodiments of the present disclosure; and

FIG. 10 is a flowchart diagram of an example process for generating a dashboard visualization based on one or more classification data objects in accordance with one or more embodiments of the present disclosure.

### DETAILED DESCRIPTION OF VARIOUS EMBODIMENTS

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### Overview

Various embodiments of the present disclosure address technical problems associated with efficiently and reliably managing server systems such as, for example, managing data objects, components and/or communications provided to a server system. The disclosed techniques can be provided by an apparatus integrated with an application framework where multiple components/resources and/or layers of components/resources interact with one another in several complex manners to provide collaborative applications and/or collaborative services.

An application framework (e.g., a cloud application framework) is typically characterized by a large number of the application components (e.g., services, micro services, and the like) that are offered by the application framework. Those application components typically include a large number of frontend application components and/or a large number of backend application components. One example application framework might include an enterprise instance of Jira®, an action tracking and project management software platform, developed by Atlassian Pty. Ltd. that may be licensed to Beta Corporation. Other software platforms may serve as application frameworks (e.g., Confluence®, Trello®, Bamboo®, Clover®, Crucible®, etc. by Atlassian Pty. Ltd) as will be apparent to one of ordinary skill in the art in view of the foregoing discussion.

Due to the scale and the numerosity of the application components, a large number of data objects may be generated by the application framework during a time interval. These created data objects may be generated for a variety of purposes and can be difficult to track due to the sheer volume data objects and due to the complexity of the application framework. For example, the application framework may be configured as a collaborative application framework and data objects may be generated as a result of events, incidents, changes, component requests, alerts, notifications, workflows, service requests, service tickets (e.g., service support tickets), and/or other dynamic data related to the collaborative application framework. The data objects generated by an application framework may also relate to a business or enterprise that has deployed or licensed the application framework for managing events, incidents, changes, component requests, alerts, notifications, workflows, service requests, service tickets, and/or other dynamic data. Additionally, data objects may be transmitted via multiple types of communication channels such as, for example, email, application portals, widgets, chat channels, application programming interface (API) calls, etc.

As an example, a data object may be related to a service ticket (e.g., a service management ticket) for a service request by a user (e.g., a help seeker user). Such a data object related to a service ticket may trigger routing to one or more system resources and/or application components of the application framework to provide one or more insights for the service ticket. However, each processing path of the application framework to provide a possible insight may result in inefficient usage of computing resources for the application framework. Moreover, given the complexity and scale of modern application frameworks, it can be difficult to manage and optimize data requirements and/or computing resources related to application components of such application frameworks. Accordingly, providing one or more insights for a service ticket is often computationally expensive and/or may unduly strain computing resources of the application framework.

It is generally also difficult to obtain meaningful information related to service tickets, service messages, workflow actions, software events, incidents, changes, component requests, alerts, notifications, and/or other data provided to such application frameworks. In particular, tickets may be created in response to problems faced by users of an application framework. For example, when users encounter problems such as bugs, errors, questions, or suggestions related to an application framework, the users may generate or otherwise cause the generation of a service ticket associated with the problem. Service tickets may include a description associated with a service request. Service tickets may additionally or alternatively include one or more data fields such as a title and/or a description that is utilized to describe a problem and/or service request. However, the volume of service tickets associated with an application framework poses a problem in itself of how to efficiently and effectively analyze the service tickets to gain insights into the problems users face.

To manage the scale, numerosity, and/or complexity of service tickets, an application framework may employ manual analysis, statistical analysis, and/or the like. For example, support teams may read and manually tag, log, or otherwise record tags associated with support tickets. In aggregate, the tags may provide insights into the problems faced by users of an application framework, but such manual processes are slow, costly, and introduce the potential for human error. In other examples, statistical analysis may be utilized to programmatically analyze service tickets, but it is a consistent struggle to effectively scale to handle large volumes of data, hindering real-time insights. Further, such systems may be complex and difficult to implement and/or analyze, creating a barrier to entry for client devices that request immediate insights and/or insights without extensive technical expertise with respect to the application framework.

To address the above-described challenges related to managing server systems and/or gaining insights from volumes of service tickets, various embodiments of the present disclosure are directed to systems, apparatuses, methods, and/or computer program products for providing insights for an application framework by analyzing service message data objects via machine learning. In various embodiments, service message data objects may be processed via supervised and/or unsupervised machine learning to provide service message classifications for the service message data objects. In some embodiments, a service message data object may correspond to a service ticket and/or data included in a service ticket. In various embodiments, a natural language processing model may be utilized to extract topics, subtopics, and/or keywords from service tickets. Additionally or alternatively, a natural language processing model may be utilized to classify service tickets, and/or the like. In various embodiments, the natural language processing model may be an unsupervised natural language processing model configured to perform topic modeling, a supervised natural language processing model configured to perform classification, and/or another type of natural language model. In some embodiments, the natural language processing model may interact with a large language model to further improve insights related to the service tickets of an application framework. In various embodiments, a large language model may be utilized to generate themes, summaries, and/or the like based on topics, subtopics, keywords, and/or other data associated with service tickets of an application framework. The large language model may be a model configured to generate contextually relevant text based on received input.

In various embodiments, the unsupervised natural language processing model may perform text analysis to generate embeddings that enable rich representations of data fields such as titles and/or descriptions of service tickets. The unsupervised natural language processing model may perform dimensionality reduction to effectively reduce high dimensionality data while maintaining global and/or local structures that enable efficient representations of the data. The unsupervised natural language processing model may perform clustering to group data based on similarities, distances, and/or the like to generate different groups of related and/or similar data. In this manner, the unsupervised natural language processing model may generate topics for a large volume of service tickets. The topics may include subtopics and/or keywords. The topics may provide a comprehensive and sophisticated generalization of the problems raised in a large volume of service tickets that might otherwise require extensive efforts and/or efforts beyond traditional technical capabilities. Additionally, by analyzing service tickets via machine learning, prerequisite knowledge of what problems might be raised in the service tickets may not be required as the unsupervised natural language processing model may structurally allow for any variety of topics to be determined.

In various embodiments, the large language model may generate themes and/or summaries of inputs. For example, topics, subtopics, keywords, and/or other data from service tickets may be input to the large language model to generate comprehensive and sophisticated themes and/or summaries representative of the various inputs. In this manner, the large language model may provide easily understandable and/or human-interpretable generalizations of problems raised in large volumes of service tickets.

In various embodiments, a topic may correspond to initial and/or unprocessed output from an unsupervised natural language processing model. Additionally, a topic may consist of one or more keyword clusters. In various embodiments, a theme may correspond to a refined representation of a topic. Additionally, a theme may be enriched through analysis of representative data and/or large language model interpretation to provide coherent and/or contextually relevant explanation of higher-order categories for service message data objects.

In various embodiments, the supervised natural language processing model may perform text analysis to generate classifications for service tickets. The supervised natural language processing model may be trained to classify service tickets using known classes such as, for example, the reason for contact associated with a service ticket. For example, a service ticket may be generated by a user that encountered a bug whereas another service ticket may be generated by a user that wishes to provide a suggestion for a functionality they would like to have implemented. In such an example, the supervised natural language processing model may be trained to classify new service tickets, for example, as bugs or suggestions. The supervised natural language processing model may undergo rigorous training and validation to determine optimal training parameters such as the learning rate, batch size, number of epochs, and/or the like. The supervised natural language processing model may also be repeatedly evaluated using various performance metrics such as, for example, the area under the curve (AUC), receiver operating characteristic curve (ROC), F1 score, and/or the like.

In various embodiments, the data generated based on and/or extracted from service tickets may be utilized to generate a dashboard visualization. The dashboard visualization may include one or more modules, widgets, and/or graphical elements configured to render, display, or otherwise present information about the service tickets of an application framework. Additionally, the machine learning models and/or dashboard visualizations utilized to obtain insights from service tickets may be integrated within an application framework.

In various embodiments, the dashboard visualization may be generated based on the outputs of the various models described herein. The dashboard visualization may provide an integrated and comprehensive view of data generated based on or extracted from service tickets to provide insights for an application framework. In an example, the dashboard visualization may provide insights based on the themes, summaries, and classifications generated based on the service tickets of an application framework. In another example, it may be desirable to a user to know that a majority of the service tickets for an application framework are complaints about a common bug within a particular service. Further, it may be desirable to the user to see supplementary visualizations, summaries, and/or the like. The dashboard visualization may additionally or alternatively enable automatic, up-to-date display of such insights without the user needing technical expertise.

In an example embodiment of the present disclosure, a theme classification workflow may be provided for service tickets. In various embodiments, pre-processing of the service tickets may be provided to allow utilization of one or more natural language processing models and/or one or more large language models. The one or more natural language processing models and/or one or more large language models may provide contextual representations of the service tickets. In various embodiments, embeddings associated with the contextual representations may be provided with dimensionality reduction and/or density-based clustering to identify coherent themes associated with service tickets. Additionally, the embeddings may be further refined via hierarchical term frequency-inverse document frequency (TF-IDF) data clustering and/or hierarchical class-based term frequency-inverse document frequency (c-TF-IDF) data clustering. In various embodiments, one or more large language models may be utilized to confirm cluster coherence and/or to generate interpretable theme descriptions. The interpretable theme descriptions may be presented via an interactive dashboard to provide deep insights into support ticket intents, patterns, and/or trends.

In another example embodiment of the present disclosure, a supervised learning workflow may be provided for service tickets. In various embodiments, the supervised learning workflow may utilize pre-processing of the service tickets to allow utilization of one or more supervised natural language processing models. In various embodiments, a feature set may be extracted from ticket text and/or metadata associated with service tickets. Additionally, one or more fine-tuned pre-trained transformer models may be utilized for a classification task associated with the service tickets. In various embodiments, a resulting model may be deployed via an API-based inference platform. As such, real-time classifications associated with service tickets may be provided. Additionally, in various embodiments, a feedback loop associated with classifications and one or more supervised natural language processing models may be utilized for continuous improvement and/or retraining of the one or more supervised natural language processing models.

In various embodiments, the machine learning techniques describes herein may be performed autonomously, periodically, and/or continuously to process service message data objects. Processing of service message data objects may include autonomous identification of patterns, topics, themes, and/or other classifications associated with service message data objects. The machine learning techniques describes herein may be additionally or alternatively performed autonomously, periodically, and/or continuously to adapt to emerging trends and/or dynamic changes with respect to an application framework in real-time or near real-time. Additionally, in various embodiments, natural language processing models and/or large language models may be configured to leverage machine learning capabilities to achieve consistent and/or scalable processing of service message data objects.

In an embodiment, a first feature set may be extracted from a plurality of service message data objects associated with an application framework. Each of the plurality of service message data objects may comprise at least a description associated with a service request by a user identifier. The first feature set may be input to an unsupervised natural language processing model to generate a plurality of topic data objects representative of the plurality of service message data objects. In some embodiments, the unsupervised natural language processing model may be an unsupervised Bidirectional Encoder Representations from Transformers (BERT) model. A second feature set may be extracted from the plurality of topic data objects. Each of the plurality of topic data objects may comprise at least a topic embedding associated with service message data object. The second feature set may be input to a large language model to generate a plurality of theme data objects where each of the plurality of theme data objects is representative of a respective topic. In various embodiments, the plurality of theme data objects may be utilized to generate a dashboard visualization for an electronic interface.

In another embodiment, a feature set may be extracted from a plurality of service message data objects associated with an application framework. Each of the plurality of service message data objects may comprise at least a description associated with a service request by a user identifier. The feature set may be input to a supervised natural language processing model to generate a plurality of classifications representative of the plurality of service message data objects. The supervised natural language processing model may be configured to classify inputs as belonging to a class of a predefined plurality of classes associated with predefined reasons for a service request. In some embodiments, the supervised natural language processing model may be a supervised BERT model. In various embodiments, the plurality of classifications may be utilized to generate a dashboard visualization for an electronic interface.

Moreover, by utilizing machine learning, a number of computing resources and/or memory allocation for providing insights related to service tickets can be reduced. In doing so, various embodiments of the present disclosure make substantial technical contributions to improving the efficiency and/or the effectiveness of an application framework. Various embodiments of the present disclosure additionally or alternatively provide improved cross-product collaboration, improved searchability, improved service request support, improved usability, improved data quality, improved interactions, improved processes, improved workflows, improved incident predictions, improved remote collaborations with respect to data related to an application framework, and/or the like. Moreover, various embodiments of the present disclosure additionally or alternatively provide improved model performance and/or formatting of data for improved machine learning modeling related to service tickets. For example, by applying a natural language model to a feature set related to service tickets, an embedding structure capable of being processed by one or more other large language models may be realized, thereby improving performance and capabilities of machine learning for a diverse number of applications.

### Definitions

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer may read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

The terms “client device,” “computing device,” “network device,” “computer,” “user equipment,” and similar terms may be used interchangeably to refer to a computer comprising at least one processor and at least one memory. In some embodiments, the client device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client device” may refer to computer hardware and/or software that is configured to access a component made available by a server. The server is often, but not always, on another computer system, in which case the client accesses the component by way of a network. Embodiments of client devices may include, without limitation, smartphones, tablet computers, laptop computers, personal computers, desktop computers, enterprise computers, and/or the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

The term “circuitry” may refer to: hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose-built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The term “component” or “application component” refers to a computer functionality or a set of computer functionalities, such as the retrieval of specified information or the execution of a set of operations, with a purpose that different clients may reuse for their respective purposes, together with the policies that should control its usage, for example, based on the identity of the client (e.g., an application, another component, etc.) requesting the component. Additionally, a component may support, or be supported by, at least one other component via a component dependency relationship. For example, a translation application stored on a smartphone may call a translation dictionary component at a server in order to translate a particular word or phrase between two languages. In such an example the translation application is dependent on the translation dictionary component to perform the translation task.

In some embodiments, a component is offered by one computing device over a network to one or more other computing devices. Additionally, the component may be stored, offered, and utilized by a single computing device to local applications stored thereon and in such embodiments a network would not be required. In some embodiments, components may be accessed by other components via a plurality of APIs, for example, JavaScript Object Notation (JSON), Extensible Markup Language (XML), Simple Object Access Protocol (SOAP), Hypertext Markup Language (HTML), the like, or combinations thereof. In some embodiments, components may be configured to capture or utilize database information and asynchronous communications via message queues (e.g., Event Bus). Non-limiting examples of components include an open source API definition format, an internal developer tool, web based HTTP components, databased components, and asynchronous message queues which facilitate component-to-component communications.

In some embodiments, a component may represent an operation with a specified outcome and may further be a self-contained computer program. In some embodiments, a component from the perspective of the client (e.g., another component, application, etc.) may be a black box (e.g., meaning that the client need not be aware of the component's inner workings). In some embodiments, a component may be associated with a type of feature, an executable code, two or more interconnected components, and/or another type of component associated with an application framework.

In some embodiments, a component may correspond to a service (e.g., a web service). Additionally or alternatively, in some embodiments, a component may correspond to a library (e.g., a library of components, a library of services, etc.). Additionally or alternatively, in some embodiments, a component may correspond to one or more modules. Additionally or alternatively, in some embodiments, a component may correspond to one or more machine learning models. For example, in some embodiments, a component may correspond to a service associated with a type of service, a service associated with a type of library, a service associated with a type of feature, a service associated with an executable code, two or more interconnected services, and/or another type of service associated with an application framework. The term “component object identifier” refers to one or more data items or elements by which a component object may be uniquely identified. The component object identifier may include, for example, one or more of Internet Protocol (IP) addresses associated with a component, Uniform Resource Locators (URLs) associated with a component, numerical characters, alphabetical characters, alphanumeric codes, American Standard Code for Information Interchange (ASCII) characters, encryption keys, identification certificates, the like, or combinations thereof. An example embodiment of a component object identifier may comprise data provided by at least a component author, for example, a URL and a payload associated with a component. In some embodiments, the payload comprises a JSON formatted text that is either posted, by way of an HTTP POST, to a component when a resource is created or returned from a component, through an HTTP GET, when at least a resource is requested from the component.

The term “application framework” refers to a computing environment associated with one or more computing devices and one or more components (e.g., one or more application components), where the environment enables interactions with respect to components supporting at least one application. For example, an application framework may be a system (e.g., a server system, a cloud-based system, an enterprise system, etc.) where multiple components, multiple resources associated with components, multiple layers of components, and/or multiple layers of resources interact with one another in several complex manners. In some embodiments, the components are associated directly or indirectly with an application supported by the components. In some embodiments, the components may support the application over one or more communication networks. The application framework may include one or more components to generate and update a repository of collected information for each component (e.g., an event object repository). Accordingly, the application framework may provide for the collection of information, in the form of event objects, to facilitate monitoring of event streams associated with one or more components of the application framework. In certain embodiments, the application framework may be configured as a collaborative application framework that manages one or more collaborative applications such as, for example, one or more collaborative document applications, collaborative software development applications, and/or one or more other types of collaborative applications. In certain embodiments, the application framework may be configured as an enterprise instance of a collaboration and knowledge base component platform for managing documents and/or encouraging collaboration among users. In certain embodiments, the application framework may be configured as a service management software platform. In certain embodiments, the application framework may alternatively be configured to manage one or more project management applications, one or more work management applications, one or more software development applications, one or more product development applications, one or more portfolio management applications, or one or more other types of applications. In certain embodiments, the application framework may be configured as an enterprise instance of an information technology service management software platform. However, it is to be appreciated that, in other embodiments, the application framework may be configured as another type of component platform.

The term “application framework system” refers to a system that includes both a server framework and a repository framework to support the server framework. For example, an application framework refers to a system that includes a computing environment associated with one or more computing devices and one or more components, as well as a repository of collected information for each component and/or each computing device.

The term “application,” “app,” or similar terms refer to a computer program or group of computer programs designed for use by and interaction with one or more networked or remote computing devices. In some embodiments, an application refers to a mobile application, a desktop application, a command line interface (CLI) tool, or another type of application. Examples of an application comprise workflow engines, component desk incident management, team collaboration suites, cloud components, word processors, spreadsheets, accounting applications, web browsers, email clients, media players, file viewers, videogames, and photo/video editors. An application may be supported by one or more components either via direct communication with the component or indirectly by relying on a component that is in turn supported by one or more other components.

The term “service” refers to a type of component. In some embodiments, a service provides a visual representation of one or more data structures. In some embodiments, a service is configured for viewing data, searching for data, creating data, updating data, managing relationships among data, assigning attributes related to data, and/or storing data associated with one or more data structures. In some embodiments, a service is configured as a system, tool or product to facilitate viewing data, searching for data, creating data, updating data, managing relationships among data, assigning attributes related to data, and/or storing data associated with one or more data structures. In some embodiments, a service comprises a set of metadata attributes associated with a technical capability, a technical configuration, an application capability, an application configuration, and/or another metadata attribute. In some embodiments, a service is published to one or more client devices via one or more APIs. In some embodiments, a service is a logical representation of an application stack. In some embodiments, a service corresponds to one or more microservices.

The term “microservices” refers to a set of services that are interconnected and independently configured to provide a monolith service. In some embodiments, a microservice is configured with one or more APIs integrated with one or more other microservices and/or one or more other applications. In some embodiments, a microservice is a single-function module with a defined set of interfaces and/or a defined set of operations configured to integrate with one or more other microservices and/or one or more other applications to provide a monolith service.

The term “dependency relationship” or similar terms refer to an exchange of data and/or functionality between a first component and a second component. For example, the first component may be directly dependent upon the second component for a DNS lookup. In some embodiments, the second component may be directly dependent upon a third component whereby the first component is transitively dependent upon the third component via the second component. As such, the dependency relationship may be a direct relationship comprising two components or it may be a transitive relationship comprising a plurality of components. In some embodiments, a first component and a second component may have a plurality of dependency relationships between them. For example, the second component may perform both a lookup and access log function for the first component.

The terms “internal component,” “internal resource,” or similar terms refer to a program, application, platform, or component that is configured by a developer to provide functionality to another one or more of their programs, applications, platforms, or components, either directly or indirectly through one or more other components, as opposed to using an external component. Internal components operate on a compiled code base or repository that is at least partially shared by an application which utilizes the functionality provided by the internal component. In some embodiments, the application code base and the internal component code base are hosted on the same computing device or across an intranet of computing devices. An application communicates with internal components within a shared architectural programming layer without external network or firewall separation. In some embodiments, an internal component is used only within the application layer which utilizes the internal components functionality. Information related to internal components may be collected and compiled into component objects which may also be referred to as internal component objects. An example embodiment of an internal component is a load balancer configured for routing and mapping API and/or component locations. Internal components may be configured for information-based shard routing, or in other words, routing and mapping API and/or component locations based on predefined custom component requirements associated with an application. For example, an internal component may be configured to identify where communication traffic originates from and then reply to the communications utilizing another component for reply communication.

The terms “external component,” “external resource,” “remote resource,” or similar terms refer to a program, application, platform, or component that is configured to communicate with another program, application, platform, or component via a network architecture. In some embodiments, communications between an external component and an application calling the external component takes place through a firewall and/or other network security features. The external component operates on a compiled code base or repository that is separate and distinct from that which supports the application calling the external component. The external components of some embodiments generate data or otherwise provide usable functionality to an application calling the external component. In other embodiments, the application calling the external component passes data to the external component. In some embodiments, the external component may communicate with an application calling the external component, and vice versa, through one or more APIs. For example, the application calling the external component may subscribe to an API of the external component that is configured to transmit data. In some embodiments, the external component receives tokens or other authentication credentials that are used to facilitate secure communication between the external component and an application calling the external component in view of the applications network security features or protocols (e.g., network firewall protocols). An example embodiment of an external component may include cloud components (e.g., AWS®).

The term “repository” refers to a database, a datastore, and/or a memory device which is accessible by one or more computing devices for retrieval and storage of one or more data components, the like, or combinations thereof. The repository may be configured to organize data components stored therein in accordance with one or more particular data classification labels or other attributes attributed to the data component (e.g., a scoring metric, file size, file type, etc.). For example, a repository may be structured in accordance with one or more data components associated with one or more services, applications, data classification labels, internal resources, external resources, network functions, APIs, the like, or combinations thereof. In some embodiments, a repository may be at least partially stored on one or more of a server, remotely accessible by a computing device, or on a memory device on-board the computing device.

The term “service message data object” refers to a data structure that represents at least a portion of a service message related to a service request for the application framework system. The service message data object can take the structural form of a vector or other appropriate data structure for representing a service message. Additionally, a service message data object can be received by one or more computing devices (e.g., servers, systems, platforms, etc.) which are configured to cause an application framework system to perform one or more actions associated with one or more service event workflows and/or one or more components of the application framework system. In some embodiments, a service message data object may be associated with an information technology (IT) support ticket. In some embodiments, a service message data object may be associated with an incident, problem, change, and/or the like associated with an application framework. In some embodiments, a service message data object may be associated with an incident, problem, change, and/or the like associated with a client device. In some embodiments, a service message data object may be associated with an incident, problem, change, and/or the like associated with a component, service, and/or microservice of an application framework.

In some embodiments, a service message data object may be received by an application framework system via a communication channel or the like. In one or more embodiments, the service message data object may be generated by a client device via one or more computer program instructions. In various embodiments, a service message data object can be generated via a service ticket, a service message, a service request, a service conversation, an API call, an application portal, a chat message conversation, an email exchange, a web interface, a widget interface, a workflow, a collaborative dashboard, a service management application, a project management application, a work management application, a software development application, a product development application, a portfolio management application, a collaborative application, or another type of process related to an application framework.

In some embodiments, a service message data object may include one or more data fields that describe the service message data object and the reason for the service message data object. For example, a service message data object may include a label, description data field, metadata, and/or the like, descriptive of the reason for the service message data object. For example, a service message data object may include a label, description data field, and/or the like that describes a formal request for something new to be provided, an unplanned event that disrupts or reduces the quality of a service, the underlying cause of a recurring or preventable incident, a suggestion for a new feature or functionality for a service, the adding, modifying, or removing of something that could affect a service, and/or the like.

In some embodiments, a service message data object may be utilized, processed, and/or analyzed to generate one or more feature sets. For example, one or more data fields of a plurality of service message data objects may be extracted to generate a feature set. In some embodiments, service message data objects may be used to extract insights into an application framework. For example, because a service message data object may be generated in response to a service request, incident, problem, or change associated with an application framework, a plurality of service message data objects may be indicative of common problems, desires, software errors, friction points of collaborative applications, failure points in workflows, and/or the like.

In some embodiments, within a representational hierarchy associated with an application framework, a service message data object may be considered a representation of a service request associated with the application framework that is a lower-order representation than a topic data object and/or a theme data object. For example, if a user submits a service request associated with an application framework, the user may generate or otherwise cause generation of a service message data object that is directly associated with the service request. In this manner, the service message data object may be considered most directly representative of the service request of the user as compared to a topic data object and/or a theme data object. In some embodiments, to address service requests associated with an application framework, various orders of hierarchical representation of the service request may be useful. For example, various natural language processing techniques and/or analyses described herein may be applied to feature sets extracted from service message data objects to generate higher-order representations of service requests than service message data objects (e.g., topic data objects, theme data objects). By generating various higher-order representations of service requests, easily interpretable and contextually relevant insights may be programmatically extracted and used to address the service requests.

The term “label” refers to a textual data field descriptive of a data object. In some embodiments, a label may be a class, classification, prediction, inference, tag, sentiment, embedding, title, or any other type of label with respect to data object. For example, a label may be a descriptive label assigned to a data object by a user of an application framework, a machine learning model, and/or the like. By way of example, a label may be a service message label associated with a service message data object and representative of a service request such as, for example, an incident, problem, change, suggestion, and/or the like as described by the service message data object. In another example, a label may refer to a topic label associated with a topic data object and representative of a topic. In another example, a label may refer to a theme label associated with a theme data object and representative of a theme. In yet another example, a label may refer to a class label associated with a classification data object and representative of a class.

The term “description data field” refers to a data field of a service message data object that contains data descriptive of the service message data object. For example, a description data field may include a description of a service request provided as input to a client device. In another example, a description data field may include a description of a service request provided to an automated system such as, for example, a chat bot, and/or some combination thereof. In another example, a description data field may be descriptive of a software error, suggestion, concern, change, and/or the like, associated with an application framework. In one example, a description data field may be descriptive of a suggestion for a new tool or functionality desired by a user of an application framework. In another example, a description data field may be descriptive of an incident such as a software error encountered within a service associated with an application framework. In some examples, a description data field may be descriptive of an outage, change, and/or other undesirable functionality related to a service associated with an application framework.

The term “feature set” refers to one or more features, data items, data elements, or data fields associated with one or more data objects that are collected and represented as part of a feature set. In some embodiments, a feature set may refer to any information associated with a service message data object, a client device associated with a service message data object, a topic data object, and/or the like, such as, for example, unstructured service message data, metadata, a source identifier, a user identifier, one or more object types, feature extraction data, a label, description data field, one or more keywords, one or more text features, one or more numeric features, binary encoding data, text vectorization data, segmentation data, cluster data, one or more NLP features, word encodings, TF-IDF data, c-TF-IDF data, n-gram data, named entity recognition (NER) data, one or more audio features, context data, associated computing devices, IP addresses, location information for a client device (e.g., GPS information), access logs, the like, or combinations thereof. In some embodiments, one or more machine learning models, one or more machine learning model techniques, and/or the like may be applied to a feature set to generate one or more predictive and/or descriptive data objects (e.g., topic data objects, theme data objects). For example, an unsupervised natural language processing model, supervised natural language processing model, large language model, and/or the like may be applied to a feature set to generate topic data objects, classification data objects, theme data objects, and/or the like. In various embodiments, a feature set may be configured to provide a unique representation of a service message object, a topic data object, and/or another type of data object for utilization via an unsupervised natural language processing model, a supervised natural language processing model, a large language model, and/or another type of machine learning model. Additionally a feature set may be configured to enable an unsupervised natural language processing model, a supervised natural language processing model, a large language model, and/or another type of machine learning model to learn complex patterns and/or improve classification accuracy associated with service message data objects.

In some embodiments, one or more data processing techniques may be utilized to generate a feature set. For example, one or more data processing techniques may be applied to data from one or more service message data objects before, during, or after the generation of a feature set. In another example, one or more data processing techniques may be applied to the data from a feature set before, during, or after the generation of one or more predictive and/or descriptive data objects. By way of example, one or more data processing techniques may include or otherwise be associated with data cleansing, structured metadata extraction, data normalization, thread delineation, speaker diarisation, noise reduction, stopword removal, low-frequency term filtering, term lemmatization with respect to text, case folding with respect to text, named entity recognition, and/or the like. In some embodiments, the data cleaning may include text sanitization using regular expressions (e.g., regex-based cleaning) to remove HTML text, URLs, nonprintable characters, and/or the like from service message data objects. In some embodiments, structured metadata extraction may utilized to determine priority for processing service message data objects, identify product codes associated with service message data objects, and/or identify particular customer segments associated with service message data objects. In some embodiments, speaker diarisation may include partitioning audio data containing speech into data segments according to an identity of a speaker associated with the speech. In some embodiments, thread delineation and/or speaker diarisation may be utilized to determine conversational context associated with a service message data object. In some embodiments, the named entity recognition may be utilized to identify particular keywords, products, services, components, features, error codes, service request codes, and/or the like from service message data objects.

The term “machine learning model” refers to a data entity that describes parameters, hyper-parameters, and/or defined operations configured, trained, and/or the like to generate an output for a predictive task, a classification task, and/or a generative task using machine learning techniques. For example, a machine learning model can include one or more layers, one or more rule-based layers, one or more neural network layers, and/or one or more other types of layers that depend on trained parameters, coefficients, and/or the like. In some embodiments, machine learning model can include any type of model configured, trained, and/or the like to generate an output for a predictive task, a classification task, and/or a generative task in any predictive domain. A machine learning model can include one or more of any type of machine learning model including one or more supervised, unsupervised, semi-supervised, reinforcement learning models, and/or the like. For instance, a machine learning model may include a supervised model that can be trained using a historical training dataset. In some examples, a machine learning model can include multiple models configured to perform one or more different stages of a classification and/or prediction process. In various embodiments, a machine learning model can be configured as a neural network model, a deep learning model, a convolutional neural network (CNN) model, a natural language processing (NLP) model, a large language model (LLM), a generative model, a transformer model, and/or another type of machine learning model.

In some embodiments, a machine learning model may be designed and/or trained for a particular predictive domain associated with an application framework. In some embodiments, a machine learning model may be designed and/or trained to apply one or more machine learning techniques to a feature set associated with a service message data object, a feature set associated with a topic data object, and/or the like. In some embodiments, a machine learning model, for example, can be trained, using a historical training dataset, to generate a classification and/or prediction for a topic or theme based the feature set.

In some embodiments, a machine learning model may be designed and/or trained for one or more generative tasks associated with an application framework. In some embodiments, a machine learning model can be a generative machine learning model designed and/or trained for generating information for a service message data object, topic data object, theme data object, and/or the like. For example, a machine learning model can be a generative machine learning model configured for generating data that represents at least a portion of a theme label, theme contextual description, theme contextual recommendation, and/or the like.

The term “unsupervised natural language processing model” refers to a machine learning model configured to perform unsupervised topic modeling. In some embodiments, the unsupervised natural language processing model may be configured to generate one or more topic data objects. For example, the unsupervised natural language processing model may be applied to a feature set to generate one or more topic data objects. In some embodiments, the unsupervised natural language processing model may include one or more sub-models, algorithms, and/or the like.

In some embodiments, the unsupervised natural language processing model may include an embedding machine learning model configured to generate embeddings. In some embodiments, the embedding machine learning model may be any transformer-based model configured to generate embeddings. For example, the unsupervised natural language processing model may include a BERT model, or any other embedding machine learning model. In some embodiments, the unsupervised natural language processing model may apply the embedding machine learning model to a feature set. For example, the unsupervised natural language processing model may apply the BERT model to a feature set to generate a plurality of embeddings. In some embodiments, a topic may be extracted by utilizing one or more dimensionality reduction techniques applied to transformer-based embedding associated with text included in service message data objects. Additionally, a density-based clustering technique may be applied to the resulting reduced representation to identify groups of semantically similar service message data objects. In some embodiments, the groups of semantically similar service message data objects may be utilized to determine a thematic structure for one or more service message data objects.

In some embodiments, the unsupervised natural language processing model may include a dimensionality reduction technique configured to perform dimensionality reduction. For example, the unsupervised natural language processing model may include a Uniform Manifold Approximation and Projection (UMAP) technique, or any other dimensionality reduction technique. In some embodiments, the unsupervised natural language processing model may apply the dimensionality reduction technique to the embeddings generated by the embedding machine learning model. For example, the unsupervised natural language processing model may apply the UMAP technique may to embeddings to generate a lower dimensional representation of the embeddings. In some embodiments, the dimensionality reduction technique may reduce the complexity of a vector space (e.g., embeddings) while maintaining local and/or global structures. In this manner, certain embodiments may reduce computational complexity while maintaining high quality representations of data structures.

In some embodiments, the unsupervised natural language processing model may include a spatial clustering technique configured to perform clustering. For example, the unsupervised natural language processing model may include a Hierarchical Density Based Spatial Clustering of Applications with Noise (HDBSCAN) technique, or any other spatial clustering technique. In some embodiments, the unsupervised natural language processing model may apply the spatial clustering technique to a lower dimensional representation of embeddings. For example, the unsupervised natural language processing model may apply the HDBSCAN technique to a lower dimensional representation of embeddings to generate clusters. In some embodiments, the spatial clustering technique may cluster data structures together based on their proximity in a vector space. In this manner, various embodiments may generate clusters of service message data objects that share commonalities. In some embodiments, such clusters may represent or be associated with different topics. For example, service message data objects that are syntactically, semantically, or otherwise like one another may be clustered together and a topic may be derived from the cluster.

In some embodiments, the unsupervised natural language processing model may include a class-based weighted term technique configured to rank score (e.g., assign weights) to specific terms or features within a class (e.g., a cluster, a topic). For example, the unsupervised natural language processing model may include a c-TF-IDF technique, or any other class-based weighted term technique. In some embodiments, the unsupervised natural language processing model may apply the class-based weighted term technique to clusters to generate rank scores. For example, the unsupervised natural language processing model may apply the c-TF-IDF technique to clusters to generate rank scores for terms within the clusters. In some embodiments, the rank scores of terms within clusters may be used to identify keywords of clusters. In some embodiments, the unsupervised natural language processing model may provide hierarchical topic modeling with c-TF-IDF representations for multi-level theme discovery associated with service message data objects.

In some embodiments, the class-based weighted term technique may be used to represent term relationships with respect to topics. For example, classes or clusters of terms may be considered topics. In some embodiments, a c-TF-IDF data matrix may be utilized to represent the term relationships with respect to topics. In some embodiments, the class-based weighted term technique may be used to merge classes (e.g., clusters, topics, etc.) based on their similarities. For example, a hierarchical clustering technique may be utilized to merge topics based on respective c-TF-IDF similarity values. Additionally or alternatively, in some embodiments, one or more other techniques may be used to represent terms such as, for example, bag-of-words representations. In some embodiments, such representations may be combined in association with the merging of classes. In doing so, various insights into topic relationships (e.g., how specific terms relate to specific topics) may be provided at various levels of granularity.

The term “rank score” refers to a data metric used to evaluate the importance of a term relative to other terms within a cluster. For example, a rank score may be representative of how distinguishing, predictive, and/or import a term is to a cluster it is assigned. In some embodiments, a rank score may be generated from a class-based weighted term technique. In some embodiments, rank scores may be used to determine, identify, select, sort, and/or the like, keywords.

The term “keyword” refers to a term representative of a cluster and/or topic. In some embodiments, one or more keywords may be used to identify or represent a topic associated with a cluster. For example, a keyword may be identified as a term with semantic importance to distinguishing one cluster from another, and by extension, one topic from another. In some embodiments, a keyword may be a term associated with a rank score that satisfies a threshold or is otherwise determined to be representative of a cluster. In some embodiments, a keyword may be one of a select number of terms associated with the greatest rank scores (e.g., the top ten). In some embodiments, commonly known “stop words,” such as “to,” “the,” and “is,” may be associated with a low rank score because they may be found in any given service message data object of any given cluster and carry low semantic importance, and therefore may not be considered as keywords. Conversely, uncommon, contextually meaningful, and/or semantically meaningful terms, such as the names of certain services or terms descriptive of specific service requests (e.g., “permissions access”) may be associated with greater rank scores, and therefore may be considered as keywords. In some embodiments, one or more keywords may be, or may otherwise be associated with a topic data object, a topic label, a feature set, and/or the like. For example, a keyword associated with a greatest rank score may be a topic label. In another example, one or more keywords may be used to generate a topic label. In yet another example, one or more keywords may be included in a feature set used to generate a theme data object.

The term “topic data object” refers to a data object associated with a topic and generated by an unsupervised machine learning model based on a feature set. In some embodiments, a topic data object may be associated with a topic and representative of a plurality of service message data objects. For example, an unsupervised machine learning model may be applied to a feature set including data from a plurality of service message data objects to identify one or more topics associated with the plurality of service message data objects and generate one or more respective topic data objects. In some embodiments, a topic data object may include or otherwise be associated with a topic label, one or more keywords, and/or metadata such as, for example, rank scores representative of the importance of keywords, service message data object identifiers of service message data objects associated with the topic data object, one or more data fields of service message data objects associated with the topic data object, and/or the like. In some embodiments, a topic data object may include or otherwise be associated with data and/or metadata descriptive of service message data objects represented by the topic data object. For example, a topic data object may be used to determine which and how many service message data objects it is associated with. In some embodiments, a topic data object may be configured to leverage textual content and/or metadata associated with service message data objects. For example, a topic data objects may be generated by applying one or more natural language processing techniques to textual content of service message object and integrating one or more structured metadata features to the resulting data generated via the one or more natural language processing techniques.

In some embodiments, within a representational hierarchy associated with an application framework, a topic data object may be considered a hierarchical topic classification for one or more service message data objects. For example, a hierarchical topic classification may be a representation of one or more service requests associated with the application framework that is a higher-order representation than a service message data object and a lower-order representation than a theme data object. For example, if a plurality of users encounters a common software error in using one or more services of an application framework, the plurality of users may generate or otherwise cause generation of a plurality of respective service message data objects that are associated with that common software error, and the plurality of service message data objects may be used to generate one or more topic data objects. In this manner, a topic data object may be considered representative of a particular software error encountered by the plurality of users. However, a topic data object may include one or more data fields that represent an associated topic using terms that may be unfamiliar, specialized, ambiguous, and/or minimally contextualized, and as such, may require more domain knowledge and/or technical expertise to interpret as compared to, for example, a theme data object.

The term “topic” may refer to a simplified representation of a plurality of service message data objects. For example, a topic may be a semantic, syntactic, and/or contextual commonality identified within a plurality of service message data objects. In some embodiments, a topic may be representative of one or more service requests within an application framework. In some embodiments, a topic may be represented by a topic data object. For example, a topic may be represented by one or more data fields of a topic data object such as one or more keywords or terms such as a unigram, bigram, trigram, and/or the like. For example, a topic may be or otherwise be associated with a topic label, one or more keywords, and/or the like.

The term “large language model” refers to a generative machine learning model configured to generate an output for a particular generative task. In some embodiments, the large language model may be configured as or otherwise be associated with an autoregressive LLM, a generative pre-trained transformer (GPT) model, or another type of generative machine learning model configured to generate output for a particular generative task. In some embodiments, the large language model may be configured to generate one or more theme data objects. For example, the large language model may be applied to a feature set to generate one or more theme data objects. In some embodiments, the large language model may be configured with an attention mechanism capable of providing complex reasoning and/or summarizing capabilities associated with service message data objects.

In some embodiments, the large language model may be provided with a prompt to direct the generative task. For example, the large language model may be provided with a particular prompt in association with the feature set to direct the theme data object generated. In some embodiments, the large language model may be prompted to generate a particular kind, format, length, style, and/or the like of output. For example, one particular prompt may cause the large language model to generate a theme label, another particular prompt may cause the large language model to generate a theme contextual description, and another particular prompt may cause the large language model to generate a theme contextual recommendation. In some embodiments, a one or more prompts may be used sequentially or in combination. In some embodiments, one or more prompts may be used in combination with one or more features of a feature set. In some embodiments, a large language model may be applied to a feature set including data of a topic data object where the large language model is provided a topic label, one or more keywords, one or more data fields of one or more service message data objects associated with the topic data object such as, for example, a description data field, a service message label, one or more prompts, and/or some combination thereof. For example, a large language model may be applied to one or more keywords of a topic data object and a prompt configured to direct the large language model to generate a theme label. In another example, a large language model may be applied to one or more keywords of a topic data object, one or more description data fields of one or more respective service message data objects associated with the topic data object, and a prompt configured to direct the large language model to generate a theme label and a theme contextual description. In yet another example, a large language model may be applied to one or more keywords of a topic data object, one or more description data fields of one or more respective service message data objects associated with the topic data object, and a prompt configured to direct the large language model to generate a theme label and a theme contextual recommendation.

The term “theme data object” refers to a data object associated with a theme and generated by a large language model based on a feature set. In some embodiments, a theme data object may be associated with a theme representative of one or more topic data objects. In some embodiments, a theme data object may be associated with a theme representative of one or more topic data objects and a plurality of service message data objects. For example, a large language model may be applied to a feature set including data from one or more topic data objects to identify one or more themes associated with the one or more topic data objects and generate one or more respective theme data objects. Additionally, a large language model may be applied to a feature set including data from a plurality of service message data objects associated with a respective one or more topic data objects. For example, a theme data objects may be based on one or more topic labels, one or more keywords, one or more service message data objects associated with a topic data object, and/or the like. In some embodiments, a theme data object may include or otherwise be associated with data and/or metadata descriptive of topic data objects and/or service message data objects associated with the theme data object. For example, a theme data object may be used to determine which and how many topic data objects and/or service message data objects it is associated with. In some embodiments, a theme data object may be used in a dashboard visualization.

In some embodiments, a theme data object may include or otherwise be associated with a theme label, a theme contextual description, a theme contextual recommendation, and/or metadata such as, for example, topic data object identifiers, service message data object identifiers of service message data objects associated with topic data objects, and/or the like. In some embodiments, a theme label may be a concise representation of a theme such as one or more terms, a phrase, and/or the like. In some embodiments, a theme label may be a more easily interpretable or more elaborated representation when compared to an associated topic label. For example, a theme label may be more colloquial when compared to an associated topic label. In various embodiments, a theme label, a theme contextual description, and/or a theme contextual recommendation may capture both semantic and contextual aspects of a service message data object. For example, a theme label, a theme contextual description, and/or a theme contextual recommendation may capture both semantic and contextual aspects of an issue related to a service request included in a service ticket.

In some embodiments, a theme contextual description may be a description generated by a large language model that summarizes a theme of a theme data object in an easily understandable and contextually relevant manner. In some embodiments, a theme contextual description may be one or more sentences that accurately summarize and/or elaborate on a theme label.

In some embodiments, a theme contextual recommendation may be a recommendation generated by a large language model that provides an actionable recommendation in an easily understandable and contextually relevant manner. For example, a theme contextual recommendation may be configured in a human-interpretable format such as, for example one or more sentences that are configured to recommend to a user an action that might address one or more service requests represented by a theme. By way of example, if a plurality of service message data objects includes recommendations from users to implement a certain feature or set of capabilities associated with a service of an application framework, a theme contextual recommendation may convey such recommendations in an encompassing, succinct, and contextually relevant manner.

In some embodiments, within a representational hierarchy associated with an application framework, a theme data object may be considered a hierarchical theme classification for one or more topic data objects. For example, a hierarchical theme classification may be a representation of one or more service requests associated with the application framework that is a higher-order representation than a topic data object. For example, if a plurality of users encounters a common software error in using one or more services of an application framework, the plurality of users may generate or otherwise cause generation of a plurality of respective service message data objects that are associated with that common software error, which in turn may cause generation of one or more topic data objects each associated with a topic, which in turn may cause generation of one or more theme data objects each associated with a theme. In this manner, a theme data object may be considered representative of the common software error encountered by the plurality of users. In some embodiments, a theme data object may be configured to represent an underlying message, lesson, narrative, idea, and/or the like, in an easily understandable and highly comprehensive manner. For example, a theme data object may include one or more data fields that represent an associated theme using terms, phrases, sentences and/or the like that may be familiar, clear, simple, concise, well connected and highly cohesive, and as such, may provide a deep, yet easily interpretable representation.

The term “theme” may refer to a simplified representation of one or more topic data objects and/or a plurality of service message data objects. For example, a theme may be a semantic, syntactic, and/or contextual commonality identified within one or more topic data objects, and, in some embodiments, a plurality of service message data objects. In some embodiments, a theme may be representative of one or more service requests associated with an application framework. In some embodiments, a theme may be associated with a theme data object. For example, a theme may be represented by one or more data fields of a theme data object such as one or more terms, phrases, sentences, paragraphs, and/or the like. For example, a theme may be or otherwise be associated with a theme label, a theme contextual description, a theme contextual recommendation, and/or the like.

In a non-limiting contextual example, a large language model may be applied to a feature set. The feature set may include the following topic label from a topic data object: “Permissions Access.” Additionally, the feature set may include the following top three keywords from the topic data object: “Access,” “Permissions,” “Service A.” Additionally, the feature set may include one or more description data fields of one or more service message data objects that are most representative of the topic data object. The large language model may generate a theme data object from the feature set. The theme data object may include a theme label that states the following: “Service A User Access and Permissions.” Additionally, the theme data object may include a theme contextual description that states the following: “Customers are experiencing issues with accessing certain spaces in Service A despite having correct permissions. Some external users can view personal and restricted spaces they shouldn't have access to. There are also problems with bulk editing permissions, changing ownerships of spaces, API inconsistencies and lack of expected API calls. Also, difficulty managing multiple space permissions at once.” Additionally, the theme data object may include a theme contextual recommendation that states the following: “1) Provide bulk permissions editing. 2) Revisit the changing ownership of pages experience. A) Issues seem too often occur when users leave the company. 3) Enhance API to include better space permissions removal calls. A) Easier bulk editing permission calls. B) Find spaces by specific user and their corresponding space permissions.” In this example, the topic data object may effectively and efficiently group a plurality of service message data objects that share common issues with one or more services associated with the application framework and extract keywords representative of the associated topic. However, the topic label and keywords of the topic data object may be considered to have poor structure and/or interpretability. For example, a person having low technical expertise in topic modeling may have difficulty interpreting the data fields of a topic data object. In contrast, the theme data object's theme label, theme contextual description, and theme contextual recommendation may provide an easily interpretable and plain language or conversational structure that provides readily available insights and/or recommendations.

The term “supervised natural language processing model” refers to a machine learning model configured perform supervised classification. In some embodiments, the supervised natural language processing model may be or otherwise be associated with a BERT model configured to perform supervised classification. In some embodiments, the BERT model configured to perform classification may use the Roberta-Base tokenizer. In some embodiments, the supervised natural language processing model may be configured as or otherwise associated with a transformer model or a fine-tuned transformer model configured to perform supervised classification. In some embodiments, the supervised natural language processing model may be configured as or otherwise associated with a gradient boosting model (e.g., XGBoost) or a deep neural network with a custom or partially custom architecture configured to perform supervised classification. In some embodiments, the supervised natural language processing model may be configured for multi-label prediction associated with service message data objects. In some embodiments, the supervised natural language processing model may be configured to generate one or more classification data objects. For example, the supervised natural language processing model may be applied to a feature set to generate one or more classification data objects. In some embodiments, the supervised natural language processing model may leverage a layered feature extraction configuration to generate one or more classification data objects. For example, the supervised natural language processing model may utilize one or more pre-trained and/or fine-tuned word embedding models to represent semantic relationships. Additionally or alternatively, the supervised natural language processing model may extract one or more n-grams such as, but not limited to, unigrams, bigrams, trigrams, and/or the like to represent terms and/or an importance associated with terms. Additionally or alternatively, the supervised natural language processing model may leverage term frequency-inverse document frequency techniques, TF-IDF features, and/or the like to represent terms and/or an importance associated with terms. Additionally or alternatively, the supervised natural language processing model may incorporate domain-specific features, such as, for example, metadata extracted from service message data objects. In some embodiments, a supervised natural language processing model may be evaluated using one or more performance metrics. In some embodiments, one or more parameters of a supervised natural language processing model may be updated based on one or more performance metrics.

The term “classification data object” refers to a data object associated with a class and generated by a supervised natural language processing model. In some embodiments, a classification data object may be associated with a class and representative of a plurality of service message data objects. For example, a supervised machine learning model may be applied to a feature set including data from a plurality of service message data objects to identify one or more classes associated with the plurality of service message data objects and generate one or more respective classification data objects. In some embodiments, a class associated with a classification data object may be one of a plurality of predefined classes associated with a reason for a service message data object (e.g., a reason for contact for a service ticket). In some embodiments, a class associated with a classification data object may be represented by class label of the classification data object. In some embodiments, a classification data object may include or otherwise be associated with data and/or metadata descriptive of service message data objects classified by the classification data object. For example, a classification data object may be used to determine which and how many service message data objects it classifies. In some embodiments, a classification data object may be used in a dashboard visualization.

In a non-limiting example, consider a plurality of service message data objects associated with an application framework where some of the service message data objects make a suggestion for a service and other service message data objects report software errors encountered while using the service. A feature set may include data from the plurality of service message data objects. A supervised natural language processing model may be trained to classify service message data objects as being associated with a suggestion or a software errors. The supervised natural language processing model may be applied to the feature set to generate a first classification data object that is associated with the suggestion class, includes a class label that states “Suggestion,” and correctly classifies the service message data objects that make a suggestion for a service as being associated with the suggestion class. Additionally, the supervised natural language processing model may generate a second classification data object that is associated with the software error class, includes a class label that states “Software Error,” and correctly classifies the service message data objects that report a software error encountered as being associated with the software error class.

The term “performance metric” refers to a method, technique, process, and or the like, used to evaluate the performance of the supervised natural language processing model. For example, a performance metric maybe used to determine the accuracy of a supervised natural language processing model. In some embodiments, a performance metric may be an are under the curve (AUC) score, a receiver operating characteristic (ROC) score, an F1 score, or any other performance metric configured to provide indication of the performance of the supervised natural language processing model. In some embodiments a performance metric may be used to update one or more parameters of a machine learning model. For example, a performance metric of the supervised natural language processing model may be evaluated at a regular interval against a threshold and, if the performance metric fails to satisfy the threshold, one or more parameters of the supervised natural language processing model may be updated in response. In some embodiments, one or more parameters of the supervised natural language processing model may be updated until a threshold associated with a performance metric is satisfied.

The term “interaction signal” refers to a signal received by one or more computing devices (e.g., servers, systems, platforms, etc.) which are configured to cause an application framework system to perform one or more actions associated with one or more components of the application framework system. The interaction signal may be received via a component management interface, an API, a communication interface, the like, or combinations thereof. In one or more embodiments, the interaction signal may be generated by a client device via one or more computer program instructions. In various embodiments, an interaction signal may be generated via a collaborative application, event, event stream, or the like. Additionally or alternatively, the interaction signal may cause one or more actions, one or more changes, and/or one or more predictive inferences with respect to a collaborative application, event, event stream, or the like.

The term “interface element” refers to a rendering of a visualization and/or human interpretation of data associated with an application framework and/or a distributed ledger system. In one or more embodiments, an interface element may additionally or alternatively be formatted for transmission via one or more networks. In one or more embodiments, an interface element may include one or more graphical elements and/or one or more textual elements.

The term “visualization” refers to visual representation of data to facilitate human interpretation of the data. In some embodiments, visualization of data includes graphic representation and/or textual representation of data.

The term “graphical control element” refers to a computer input element that allows a user to enter input to facilitate one or more actions with respect to an application framework.

The term “interface area” refers to an area of an electronic interface, where the area may be situated in relation to one or more other interface areas of the electronic interface. An interface area may be comprised of groupings of pixels, or may be defined according to coordinates of a display device configured to render the interface. A size of an interface may be adjusted according to parameters associated with the display device. An interface area may include one or more interface elements. For example, an interface element may include a visualization. In certain embodiments, an interface area may include one or more graphical elements and/or or more textual elements. In certain embodiments, an interface area may be void of an interface element and/or a visualization. In certain embodiments, an interface area may include a graphical control element and/or one or more other interactive interface elements.

Thus, use of any such terms, as defined herein, should not be taken to limit the spirit and scope of embodiments of the present disclosure.

### Example System Architecture

Methods, apparatuses, and computer program products of the present disclosure may be embodied by any of a variety of devices. For example, the method, apparatus, and computer program product of an example embodiment may be embodied by a networked device (e.g., an enterprise platform, etc.), such as a server or other network entity, configured to communicate with one or more devices, such as one or more query-initiating computing devices. Additionally or alternatively, the computing device may include fixed computing devices, such as a personal computer or a computer workstation. Still further, example embodiments may be embodied by any of a variety of mobile devices, such as a PDA, mobile telephone, smartphone, laptop computer, tablet computer, wearable, the like or any combination of the aforementioned devices.

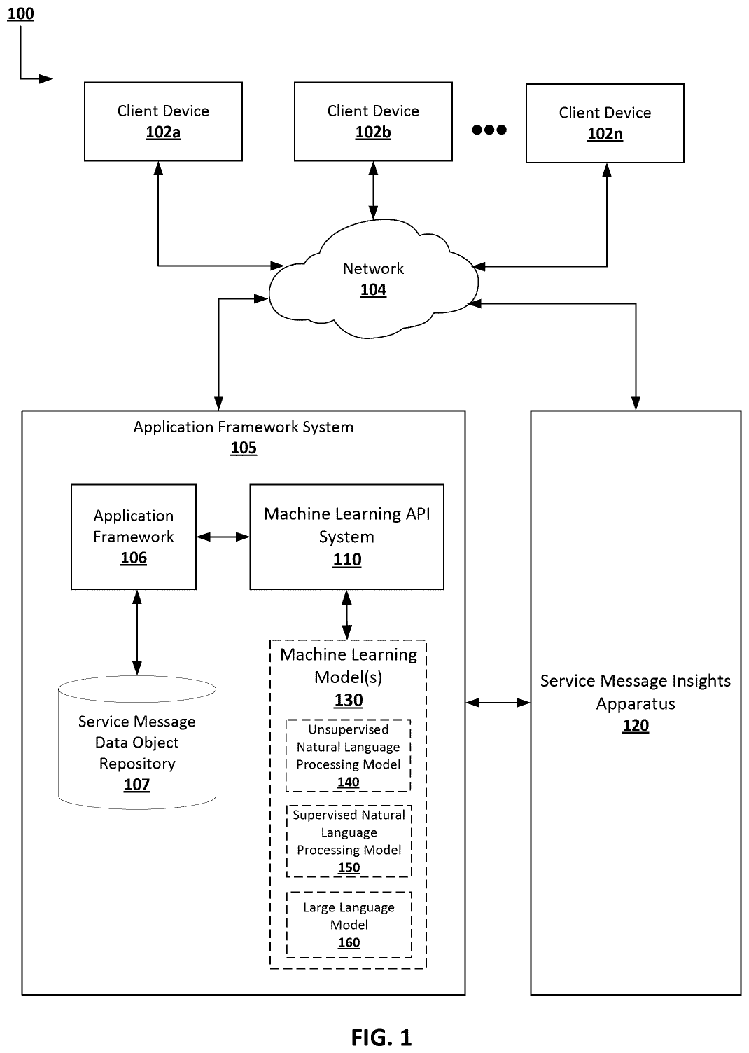

FIG. 1 illustrates an example system architecture 100 within which embodiments of the present disclosure may operate. The system architecture 100 includes an application framework system 105 configured to interact with one or more client devices 102a-n, such as client device 102a, client device 102b, and/or client device 102n. In one or more embodiments, the one or more client devices 102a-n may be configured to interact with one or more components managed by an application framework 106 of the application framework system 105. For example, in one or more embodiments, the one or more client devices 102a-n may be configured to send data to the one or more components managed by the application framework 106 and/or receive data from the one or more components managed by the application framework 106. In one or more embodiments, the one or more components may interact with one another in several complex manners to provide collaborative applications and/or collaborative services.

In one or more embodiments, the application framework system 105 includes the application framework 106, a service message data object repository 107, a machine learning API system 110, and/or one or more machine learning models 130. The service message data object repository 107 may store one or more service message data objects and/or data for one or more component objects associated therewith. In some embodiments, the one or more service message data objects stored in the service message data object repository 107 may include and/or may be stored with data sent to and/or received from the one or more components managed by the application framework 106. The service message data object repository 107 may include one or more storage units, such as multiple distributed storage units that are connected through a computer network. Each storage unit in the service message data object repository 107 may store one or more service message data objects. Moreover, each storage unit in the service message data object repository 107 may include one or more non-volatile storage or memory media including but not limited to hard disks, ROM, PROM, EPROM, EEPROM, flash memory, MMCs, SD memory cards, memory sticks, CBRAM, PRAM, FeRAM, NVRAM, MRAM, RRAM, SONOS, FJG RAM, Millipede memory, racetrack memory, the like, or combinations thereof.

The system architecture 100 also includes a service message insights apparatus 120. In an embodiment, the service message insights apparatus 120 is implemented separate from the application framework system 105. Alternatively, in certain embodiments, the application framework system 105 may include the service message insights apparatus 120. In various embodiments, the application framework system 105 and/or the service message insights apparatus 120 may also be configured to interact with the one or more client devices 102a-n. In various embodiments, the service message insights apparatus 120 may be configured to interact with application framework system 105. For example, in one or more embodiments, the service message insights apparatus 120 may be configured to interact with and/or manage one or more components of the application framework 106 and/or one or more databases 109 of the service message data object repository 107. In some embodiments, the service message insights apparatus 120 is configured to manage and/or analyze one or more service message data objects stored in the service message data object repository 107. In some embodiments, the service message insights apparatus 120 is configured to manage access to the service message data object repository 107. For example, in some embodiments, the service message insights apparatus 120 is configured to manage authorization of one or more data access requests and/or or more data write requests with respect to the service message data object repository 107.

The application framework system 105, the service message insights apparatus 120, and/or the one or more client devices 102a-n may be in communication using a network 104. Additionally or alternatively, in various embodiments, the application framework system 105 and the service message insights apparatus 120 may be in communication via a backend network and/or an enterprise network separate from the one or more client devices 102a-n. The network 104 may include any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 104 (e.g., network routers, etc.). For example, the network 104 may include a cellular telephone, an 802.11, 802.16, 802.20, and/or WiMAX network. Further, the network 104 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. In some embodiments, the protocol is a custom protocol of JSON objects sent via a WebSocket channel. In some embodiments, the protocol is JSON over RPC, JSON over REST/HTTP, the like, or combinations thereof.

A client device from the one or more client devices 102a-n may include a mobile device, a smart phone, a tablet computer, a laptop computer, a wearable device, a personal computer, an enterprise computer, a virtual reality device, or another type of computing device. In one or more embodiments, a client device from the one or more client devices 102a-n includes geolocation circuitry configured to report a current geolocation of the client device. In some embodiments, the geolocation circuitry of the client device may be configured to communicate with a satellite-based radio-navigation system such as the global position satellite (GPS), similar global navigation satellite systems (GNSS), or combinations thereof, via one or more transmitters, receivers, the like, or combinations thereof. In some embodiments, the geolocation circuitry of the client device may be configured to infer an indoor geolocation and/or a sub-structure geolocation of the client device using signal acquisition and tracking and navigation data decoding, where the signal acquisition and tracking and the navigation data decoding is performed using GPS signals and/or GPS-like signals (e.g., cellular signals, etc.). Other examples of geolocation determination include Wi-Fi triangulation and ultra-wideband radio technology.

In one or more embodiments, the application framework system 105 may be configured to receive one or more interaction signals from one or more of the client devices 102a-n. An interaction signal refers to a signal configured to cause one or more actions with respect to the application framework 106. For example, an interaction signal may be a signal configured to cause one or more actions with respect to one or more computing devices and or one or more components managed by the application framework 106. An interaction signal may be generated by the one or more client devices 102a-n and may be received via a component management interface of the application framework 106, an API of the application framework 106, a communication interface of the application framework 106, the like, or combinations thereof. Based on the one or more interaction signals, the application framework system 105 may perform one or more actions with respect to the application framework 106. In various embodiments, the one or more actions may be associated with one or more user identifiers associated with one or more events with respect to one or more components of the application framework 106. For example, the one or more actions may initiate and/or correspond to one or more events with respect to one or more components of the application framework 106. In certain embodiments, the one or more actions may be associated with one or more events with respect to a one or more computing devices and or one or more components managed by the application framework 106. In certain embodiments, the one or more actions may be associated with one or more user identifiers with respect to one or more computing devices and or one or more components managed by the application framework 106.

In some embodiments, the service message insights apparatus 120 may manage and/or configure one or more components of the application framework system 105 and/or one or more portions of the service message data object repository 107. In one or more embodiments, the service message insights apparatus 120 may programmatically determine a hierarchical theme classification for one or more service message data objects received from one or more of the client devices 102a-n and/or stored in the service message data object repository 107. In some embodiments, the service message insights apparatus 120 may determine one or more keyword embeddings for the one or more service message data objects. Additionally, the service message insights apparatus 120 may determine a theme identification and/or a human-interpretable contextual description for the one or more service message data objects. In one or more embodiments, the service message insights apparatus 120 may additionally or alternatively programmatically determine a reason classification for the one or more service message data objects. For example, the reason classification may correspond to a predetermined type of reason for a client device 102a-n providing a service message (e.g., a service ticket) to the application framework system 105. In some embodiments, the service message insights apparatus 120 may utilize the one or more keyword embeddings to determine a human-interpretable contextual description for the reason classification with respect to a particular service message data object.

In one or more embodiments, the service message insights apparatus 120 may utilize at least one machine learning model of the one or more machine learning models 130 to determine a hierarchical theme classification and/or a reason classification for one or more service message data objects. In one or more embodiments, the one or more machine learning models 130 includes an unsupervised natural language processing model 140, a supervised natural language processing model 150, and/or a large language model 160. In some embodiments, the service message insights apparatus 120 may provide a feature set associated with one or more service message data objects to the machine learning API system 110 where the machine learning API system 110 is configured to apply the unsupervised natural language processing model 140, the supervised natural language processing model 150, and/or the large language model 160 to the feature set to determine a hierarchical theme classification and/or a reason classification for the one or more service message data objects.

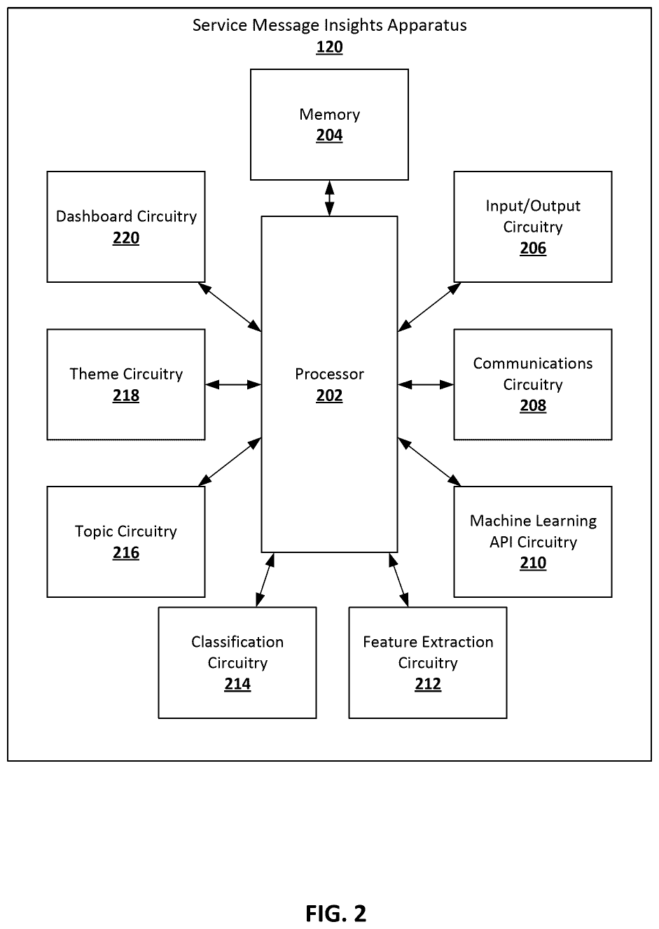

The service message insights apparatus 120 may be embodied by one or more computing systems, such the service message insights apparatus 120 illustrated in FIG. 2. In one or more embodiments, the service message insights apparatus 120 may include processor 202, memory 204, input/output circuitry 206, communications circuitry 208, machine learning API circuitry 210, feature extraction circuitry 212, classification circuitry 214, topic circuitry 216, theme circuitry 218, and/or dashboard circuitry 220. The service message insights apparatus 120 may be configured to execute the operations described herein. Although these components 202-220 are described with respect to functional limitations, it should be understood that the particular implementations necessarily include the use of particular hardware. It should also be understood that certain of these components 202-220 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present disclosure.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the techniques and/or operations described herein when the instructions are executed.

In some embodiments, the service message insights apparatus 120 may include input/output circuitry 206 that may, in turn, be in communication with processor 202 to provide output to the user and, in some embodiments, to receive an indication of a user input. In some embodiments, the input/output circuitry 206 may be configured to render a user interface. Additionally or alternatively, the input/output circuitry 206 may be configured to render and/or control a display, and may comprise a web user interface, a mobile application, a query-initiating computing device, a kiosk, or the like. In some embodiments, the input/output circuitry 206 may be communicatively coupled to and/or include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the service message insights apparatus 120. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communications circuitry 208 may include the circuitry for interacting with the antenna/antennae to cause transmission of signals via the antenna/antennae or to handle receipt of signals received via the antenna/antennae.

In some embodiments, the communications circuitry 208 may act as an intermediary for one or more components of the application framework 106. For example, the communications circuitry 208 may receive and process requests, call, messages, and/or the like for one or more components of the application framework 106. In some embodiments, the communications circuitry 208 may additionally or alternatively support data routing, traffic control, security, decryption, encryption, optimization, and/or the like for data associated with one or more components of application framework 106. For example, the communications circuitry 208 may receive a service message and perform one or more subsequent actions based on the service message. In some embodiments, the communications circuitry 208 may provide functionality of a service proxy for one or more components of the application framework 106. In some embodiments, the communications circuitry 208 may also be configured to generate access logs and/or historical data including information associated with a particular computing device, component, component object, the like, or combinations thereof.

In some embodiments, the communications circuitry 208 may be any means such as a device or circuitry embodied in either hardware or a combination of hardware and software that is configured to interact with the application framework system 105 and/or the one or more client devices 102a-n. In various embodiments, the communications circuitry 208 may monitor, analyze, and/or process data associated with the application framework system 105 such as, for example, data stored in the service message data object repository 107 and/or data related to a collaborative application. For example, in various embodiments, the communications circuitry 208 may monitor event streams associated with the application framework 106 to detect respective candidate actions related to components of the application framework 106. In certain embodiments, the communications circuitry 208 may be configured to retrieve metadata associated with the application framework 106 and/or the service message data object repository 107 to facilitate detection of respective candidate actions related to components of the application framework 106. The metadata may include, for example, data associated with relationships, sources, targets, ownership, consumption, libraries, activities, attributes, incidents, communication channels, dashboards, data repositories, labels, descriptions, and/or other data related to the application framework 106 and/or the service message data object repository 107. In some embodiments, to facilitate monitoring of event streams, the communications circuitry 208 may be configured to ping one or more computing devices of the application framework 106, such as via an internet control message protocol, to receive information related to one or more components of the application framework 106. In some embodiments, to obtain data objects associated with service messages, the communications circuitry 208 may transmit one or more API calls to one or more API servers associated with the noted client devices.

The machine learning API circuitry 210 may be any means such as a device or circuitry embodied in either hardware or a combination of hardware and software that is configured to interact with the application framework 106 and/or the one or more machine learning models 130 of the application framework 106. For example, the machine learning API circuitry 210 may be any means such as a device or circuitry embodied in either hardware or a combination of hardware and software that is configured to interact with the unsupervised natural language processing model 140, the supervised natural language processing model 150, and/or the large language model 160. In some embodiments, the machine learning API circuitry 210 may be configured to provide one or more feature sets to the one or more machine learning models 130 (e.g., the unsupervised natural language processing model 140, the supervised natural language processing model 150, and/or the large language model 160). Additionally or alternatively, the machine learning API circuitry 210 may be configured to initiate execution of the one or more machine learning models 130 (e.g., the unsupervised natural language processing model 140, the supervised natural language processing model 150, and/or the large language model 160) based on the one or more feature sets. In various embodiments, the machine learning API circuitry 210 may interact with the one or more machine learning models 131 to generate one or more topic data objects, one or more theme data objects, and/or one or more classification data objects.

The feature extraction circuitry 212 may be any means such as a device or circuitry embodied in either hardware or a combination of hardware and software that is configured to extract a feature set from one or more service message data objects, one or more topic data objects, one or more classification data objects, and/or one or more other types of data objects associated with the application framework 106. In one or more embodiments, the feature extraction circuitry 212 may be any means such as a device or circuitry embodied in either hardware or a combination of hardware and software that is configured to extract a feature set from one or more service message data objects stored in the service message data object repository 107. In some embodiments, the feature extraction circuitry 212 may extract a first feature set from a plurality of service message data objects associated with the application framework 106. Additionally or alternatively, in some embodiments, the feature extraction circuitry 212 may extract a second feature set from a plurality of topic data objects. Additionally or alternatively, in some embodiments, the feature extraction circuitry 212 may extract a feature set from a plurality of service message data objects associated with the application framework 106.

The classification circuitry 214 may be any means such as a device or circuitry embodied in either hardware or a combination of hardware and software that is configured to initiate and/or execute one or more classification processes to provide one or more classifications for one or more service message data objects. In one or more embodiments, the classification circuitry 214 may be any means such as a device or circuitry embodied in either hardware or a combination of hardware and software that is configured to initiate and/or execute one or more supervised classification processes, one or more unsupervised classification processes, and/or one or more large langue modeling classification processes to provide one or more classifications for one or more service message data objects. In some embodiments, the classification circuitry 214 may apply the supervised natural language processing model 150 to a feature set to generate a plurality of classification data objects associated with a plurality of service message data objects. A classification data object may classify a service message data object as belonging to one of a plurality of predefined classes. In some embodiments, a predefined class may correspond to a particular reason for a service message associated with the service message data object.

The topic circuitry 216 may be any means such as a device or circuitry embodied in either hardware or a combination of hardware and software that is configured to initiate and/or execute one or more processes to generate one or more topic data objects associated with one or more service message data objects. In some embodiments, the topic circuitry 216 may apply the unsupervised natural language processing model 140 to a first feature set associated with a plurality of service message data objects to generate a plurality of topic data objects representative of respective hierarchical topic classifications for the plurality of service message data objects. In some embodiments, the topic circuitry 216 may apply the unsupervised natural language processing model 140 to the first feature set to generate a plurality of embeddings representative of the first feature set.

In some embodiments, the unsupervised natural language processing model 140 includes and/or utilizes a dimensionality reduction technique. Additionally, the topic circuitry 216 may apply the dimensionality reduction technique to the plurality of embeddings to generate a lower dimensional representation of the plurality of embeddings. In some embodiments, the unsupervised natural language processing model 140 additionally or alternatively includes and/or utilizes a spatial clustering technique. Additionally, the topic circuitry 216 may additionally or alternatively apply the spatial clustering algorithm to the lower dimensional representation of the plurality of embeddings to generate a plurality of cluster data objects. In some embodiments, the unsupervised natural language processing model 140 includes and/or utilizes a class-based weighted term technique. Additionally, the topic circuitry 216 may apply the class-based weighted term technique to the plurality of cluster data objects to generate a rank score for each keyword of a plurality of keywords. The plurality of keywords may be associated with a cluster data object of the plurality of cluster data objects. Additionally, the rank score may be indicative of the importance of a respective keyword.

The theme circuitry 218 may be any means such as a device or circuitry embodied in either hardware or a combination of hardware and software that is configured to initiate and/or execute one or more processes to generate one or more theme data objects associated with one or more service message data objects. In some embodiments, the theme circuitry 218 may apply the large language model 160 to a second feature set associated with a plurality of topic data objects to generate a plurality of theme data objects representative of respective hierarchical theme classifications for the plurality of topic data objects. The respective hierarchical theme classifications may be representative of a higher-order hierarchical classification as compared to the respective hierarchical topic classifications. In some embodiments, the large language model 160 may be an autoregressive large language model that is configured to generate a textual output based on a textual input.

The dashboard circuitry 220 may be any means such as a device or circuitry embodied in either hardware or a combination of hardware and software that is configured to initiate a rendering of a dashboard visualization via an electronic interface. In some embodiments, the dashboard circuitry 220 may initiate a rendering of a dashboard visualization via an electronic interface based on a plurality of theme data objects and/or a plurality of topic data objects. In some embodiments, the dashboard circuitry 220 may additionally or alternatively initiate a rendering of a dashboard visualization via an electronic interface based on a plurality of classification data objects. In some embodiments, the dashboard visualization may additionally or alternatively include a rendering of one or more theme contextual descriptions, one or more them contextual recommendations, theme labels, class labels, and/or metadata associated with one or more service message data objects.

In some embodiments, one or more external systems (such as a remote cloud computing and/or data storage system) may also be leveraged to provide at least some of the functionality discussed herein.

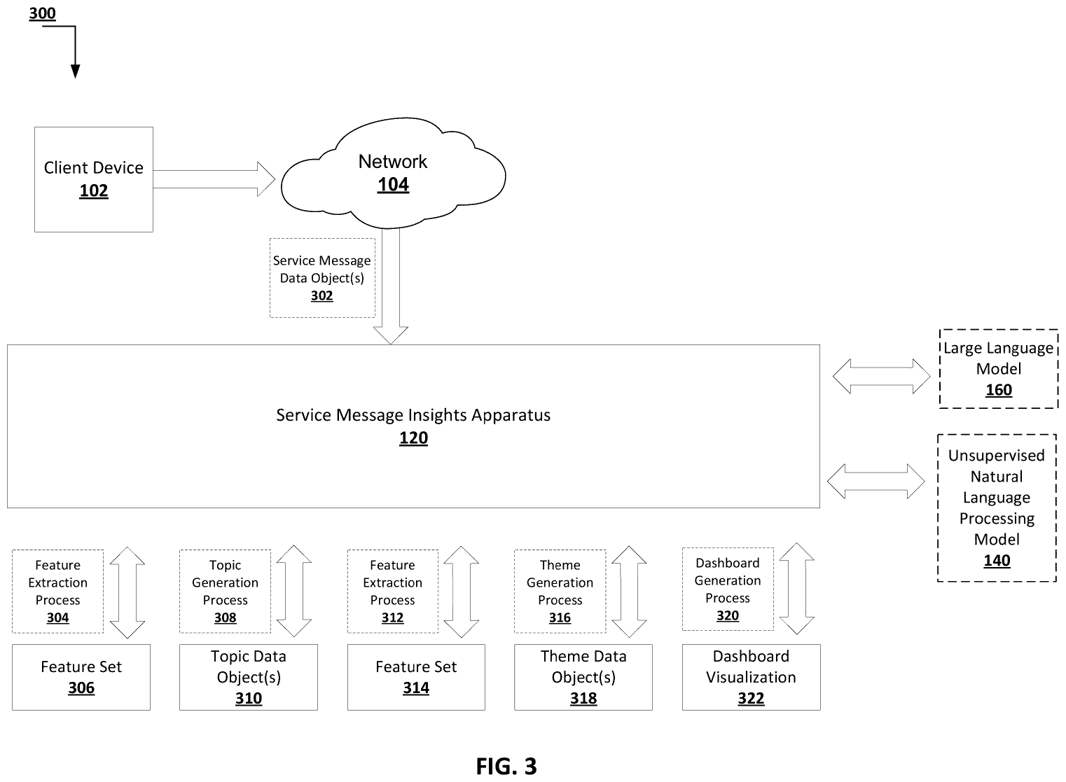

Referring to FIG. 3, an example data flow 300 is presented in accordance with one or more embodiments of the present disclosure. The data flow 300 depicts functionality between various sub-systems of the present disclosure, including the client device 102, the network 104, the service message insights apparatus 120, the large language model 160, the unsupervised natural language processing model 140, a feature set 306, one or more topic data objects 310, feature set 314, one or more theme data objects 318, and/or a dashboard visualization 322. One or more portions of the data flow 400 may be executed and/or performed by the service message insights apparatus 120. In one or more embodiments, the data flow 300 may be associated with a process executed and/or performed by the service message insights apparatus 120 for initiating a dashboard visualization 322 based on the one or more service message data objects 302, the one or more topic data objects 310, and/or the one or more theme data objects 318. In some embodiments, the one or more service message data objects 302 may be associated with the service message data object repository 107.

In one or more embodiments, the service message insights apparatus 120 may receive, via the network 104, one or more service message data objects 302 from the client device 102. The one or more service message data objects 302 may be, for example, one or more service tickets, one or more service messages, one or more service requests, and/or the like, associated with the application framework 106. In some embodiments, a service message data object of the one or more service message data objects 302 may include or otherwise be associated with a service message label, a description data field, metadata, and/or the like. In some embodiments, a service message data object of the one or more service message data objects 302 may be configured as an interaction signal. In some embodiments, a service message data object of the one or more service message data objects 302 may be generated via a graphical control element of an electronic interface of the client device 102.

In some embodiments, the service message insights apparatus 120 may perform one or more operations based on the service message data objects 302. For example, the service message insights apparatus 120 may perform the feature extraction process 304. Via the feature extraction process 304, the service message insights apparatus 120 may generate the feature set 306. The feature set 306 may include data extracted from the one or more service message data objects 302 such as, for example, service message labels, description data fields, metadata describing the service message data objects 302, and/or the like.

In some embodiments, the service message insights apparatus 120 may apply one or more machine learning models 130 to the feature set 306. For example, via the topic generation process 308, the service message insights apparatus 120 may apply the unsupervised natural language processing model 140 to the feature set 306 to generate the one or more topic data objects 310. The topic generation process 308 may be, for example, an unsupervised topic modeling process in which the unsupervised natural language processing model 140 identifies one or more topics associated with one or more service message data objects 302 based on the feature set 306. In some embodiments, each topic data object of the one or more topic data objects 310 may be associated with a respective topic. Additionally, a topic data object of the one or more topic data objects 310 may include or otherwise be associated with, for example, one or more keywords, a topic label, metadata associated with one or more service message data objects 302, metadata associated with a respective topic data object itself, and/or the like.

In some embodiments, the service message insights apparatus 120 may perform the feature extraction process 312. Via the feature extraction process 312, the service message insights apparatus 120 may generate the feature set 314. The feature set 314 may include data extracted from the one or more topic data objects 310, such as, for example, one or more topic labels, one or more keywords, metadata, and or the like. Additionally, in some embodiments, the feature set 314 may include data extracted from one or more service message data objects 302 such as, for example, service message labels, description data fields, metadata and/or the like.

In some embodiments, the service message insights apparatus 120 may apply one or more machine learning models 130 to the feature set 314. For example, via the theme generation process 316, the service message insights apparatus 120 may apply the large language model 160 to the feature set 314 to generate the one or more theme data objects 318. The theme generation process 316 may be, for example, a process in which one or more data fields from the feature set 314 and one or more prompts are input to the large language model 160 to direct the large language model 160 to identify one or more themes and/or respectively generate the one or more theme data objects 318. In some embodiments, each theme data object of the one or more theme data objects 318 may be associated with a respective theme. Additionally, a theme data object of the one or more theme data objects 318 may include or otherwise be associated with, for example, a theme label, a theme contextual description, a theme contextual recommendation, metadata associated with one or more service message data objects 302, metadata associated with one or more topic data objects 310, metadata associated with a respective theme data object itself, and/or the like.

In some embodiments, the service message insights apparatus 120 may perform the dashboard generation process 320. Via the dashboard generation process 320, the service message insights apparatus 120 may generate the dashboard visualization 322 based at least in part on the one or more theme data objects 318, one or more topic data objects 310, and/or one or more service message data objects 302. In some embodiments, the dashboard visualization 322 is configured to display a predetermined format for displaying data based on the one or more theme data objects 318. In some embodiments, the dashboard visualization 322 may include one or more interface modules each configured to display a predetermined format for displaying data based on the one or more theme data objects 318.

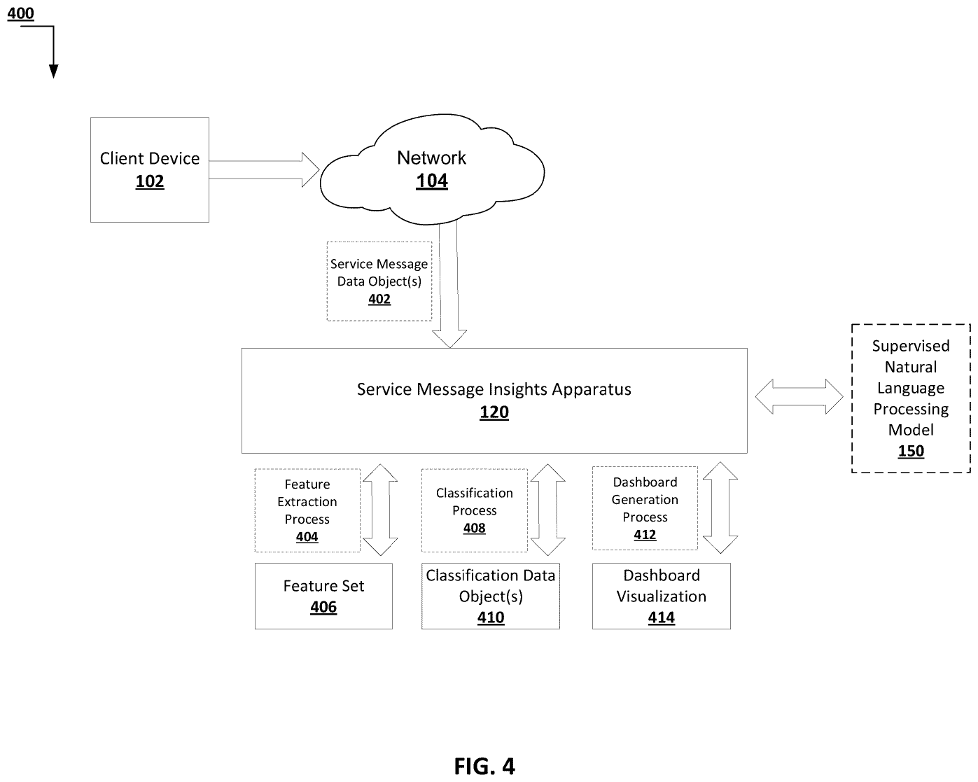

Referring to FIG. 4, an example data flow 400 is presented in accordance with one or more embodiments of the present disclosure. The data flow 400 depicts functionality between various sub-systems of the present disclosure, including the client device 102, the network 104, the service message insights apparatus 120, the supervised natural language processing model 150, a feature set 406, one or more classification data objects 410, and/or a dashboard visualization 414. One or more portions of the data flow 400 may be executed and/or performed by the service message insights apparatus 120. In one or more embodiments, the data flow 400 may be associated with a process executed and/or performed by the service message insights apparatus 120 for initiating the dashboard visualization 414 using the one or more service message data objects 402 and/or the one or more classification data objects 410. In some embodiments, the one or more service message data objects 302 may be associated with the service message data object repository 107.

In one or more embodiments, the service message insights apparatus 120 may receive, via the network 104, the one or more service message data objects 402 from the client device 102. The one or more service message data objects 402 may be, for example, one or more service tickets, one or more service messages, one or more service requests, and/or the like, associated with the application framework 106. In some embodiments, a service message data object of the one or more service message data objects 402 may include or otherwise be associated with a service message label, a description data field, metadata, and/or the like. In some embodiments, a service message data object of the one or more service message data objects 402 may be configured as an interaction signal. In some embodiments, a service message data object of the one or more service message data objects 402 may be generated via a graphical control element of an electronic interface of the client device 102.

In some embodiments, the service message insights apparatus 120 may perform one or more operations based on the one or more service message data objects 402. For example, the service message insights apparatus 120 may perform the feature extraction process 404. Via the feature extraction process 404, the service message insights apparatus 120 may generate the feature set 406. The feature set 406 may include data extracted from the one or more service message data objects 402 such as, for example, service message labels, description data fields, metadata describing the one or more service message data objects 402, and/or the like.

In some embodiments, the service message insights apparatus 120 may apply one or more machine learning models 130 to the feature set 406. For example, via the classification process 408, the service message insights apparatus 120 may apply the supervised natural language processing model 150 to the feature set 406 to generate the one or more classification data objects 410. The classification process 408 may be, for example, a supervised classification process in which the supervised natural language processing model 150 classifies each service message data object of the one or more service message data objects 402 as belonging to one of a set of predefined classes based on the feature set 406. In some embodiments, each classification data object of the one or more classification data objects 410 may be associated with a respective class. A classification data object of the one or more classification data objects 410 may include or otherwise be associated with, for example, a class label, metadata associated with one or more service message data objects, metadata associated with a respective classification data object itself, and/or the like.

In some embodiments, the service message insights apparatus 120 may perform the dashboard generation process 412. Via the dashboard generation process 412, the service message insights apparatus 120 may generate the dashboard visualization 414 based at least in part on the one or more classification data objects 410. In some embodiments, the dashboard visualization 414 is configured to display a predetermined format for displaying data based on the one or more classification data objects 410. In some embodiments, the dashboard visualization 414 may include one or more interface modules each configured to display a predetermined format for displaying data based on the one or more classification data objects 410.

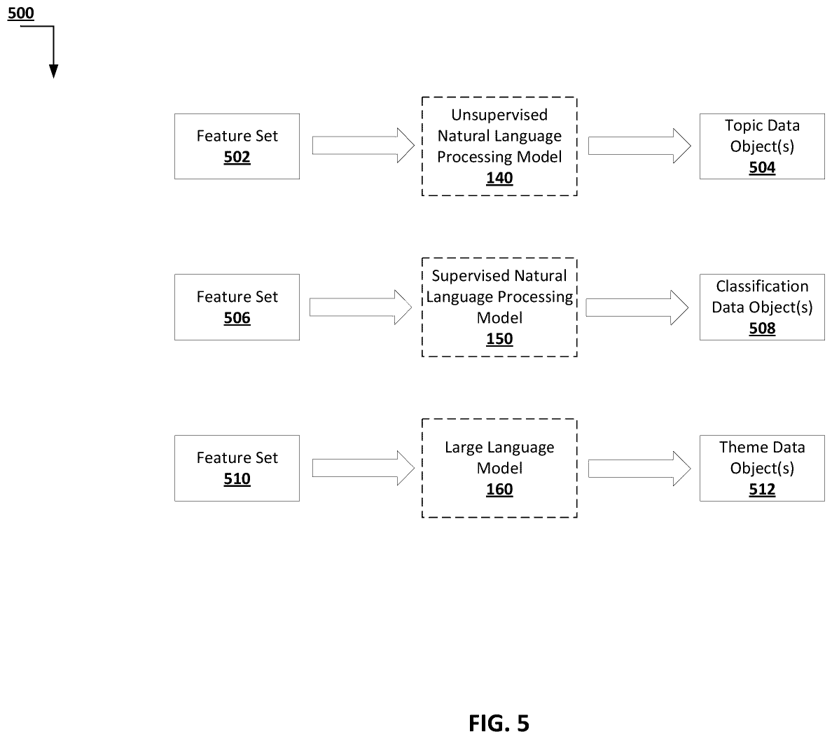

Referring to FIG. 5, an example data flow 500 is presented in accordance with one or more embodiments of the present disclosure. The data flow 500 depicts various feature inputs and outputs of various machine learning models of the present disclosure, including a feature set 502 associated with the unsupervised natural language processing model 140, one or more topic data objects 504 associated with the unsupervised natural language processing model 140, a feature set 506 associated with the supervised natural language processing model 150, one or more classification data objects 508 associated with the supervised natural language processing model 150, a feature set 510 associated with the large language model 160, and/or one or more theme data objects 512 associated with the large language model 160.

In some embodiments, the feature set 502 is extracted from one or more service message data objects associated with the application framework 106. For example, in some embodiments, the feature set 502 may correspond to the feature set 306 associated with the feature extraction process 304. The feature set 502 may include, for example, service message labels, description data fields, metadata, and/or the like, extracted from one or more service message data objects. In some embodiments, the feature set 502 is input into the unsupervised natural language processing model 140. The unsupervised natural language processing model 140 may be, for example, a machine learning model configured to perform unsupervised topic modeling. In some embodiments, the unsupervised natural language processing model 140 may generate the one or more topic data objects 504 based on the feature set 502. Each topic data object of the one or more topic data objects 504 may include or otherwise be associated with a topic identified by the unsupervised natural language processing model 140. Each topic data object of the one or more topic data objects 504 may include, for example, a topic label, one or more keywords, metadata, and/or the like.

In some embodiments, the feature set 506 is extracted from one or more service message data objects associated with the application framework system 105. For example, in some embodiments, the feature set 506 may correspond to the feature set 406 associated with the feature extraction process 404. The feature set 506 may include, for example, service message labels, description data fields, metadata, and/or the like, extracted from one or more service message data objects. In some embodiments, the feature set 506 is input into the supervised natural language processing model 150. The supervised natural language processing model 150 may be, for example, a machine learning model configured to perform supervised classification. In some embodiments, the supervised natural language processing model 150 may generate one or more classification data objects 508 based on the feature set 506. Each classification data object 508 may be associated with a class identified by the supervised natural language processing model 150 of a set of predefined classes. Each classification data object 508 may include, for example, a class label, metadata, and/or the like.

In some embodiments, the feature set 510 is extracted from the one or more topic data objects 504. Additionally, in some embodiments, the feature set 510 includes data extracted from one or more service message data objects. For example, in some embodiments, the feature set 510 may correspond to the feature set 314 associated with the feature extraction process 312. The feature set 510 may include, for example, topic labels, one or more keywords, service message labels, description data fields, metadata, and/or the like, extracted from the one or more topic data objects 504 and/or one or more service message data objects. In some embodiments, the feature set 510 is input into the large language model 160. Additionally, in some embodiments, one or more prompts may be input to large language model 160 to direct the output of the large language model. The large language model 160 may be, for example, a machine learning model configured to perform a generative task. In some embodiments, the large language model 160 may generate the one or more theme data objects 512 based on the feature set 510 and/or one or more prompts. Each theme data object 512 of the one or more theme data objects 512 may be associated with a theme identified by the large language model 160. Additionally or alternatively, each theme data object of the one or more theme data objects 512 may include, for example, a theme label, a theme contextual description, a theme contextual recommendation, metadata, and/or the like.

In some embodiments, the feature set 502 may be generated based on the large language model 160 or another large language model. For example, a feature set may be extracted from one or more one or more service message data objects (e.g., the one or more one or more service message data objects 302). Additionally, the large language model 160 or another large language model may be applied to the feature set associated with the one or more service message data objects to generate at least a portion of the feature set 502 to further improve topic classification and/or generation of the one or more topic data objects 504 via the unsupervised natural language processing model 140.

In some embodiments, output of the unsupervised natural language processing model 140 may be provided as input to the large language model 160 or another large language model to further improve quality and/or refine the data of the one or more topic data objects 504.

In some embodiments, the feature set 506 may be generated based on the large language model 160 or another large language model. For example, a feature set may be extracted from one or more one or more service message data objects (e.g., the one or more service message data objects 402). Additionally, the large language model 160 or another large language model may be applied to the feature set associated with the one or more service message data objects to generate at least a portion of the feature set 506 to further improve classification and/or generation of the one or more classification data objects 508 via the supervised natural language processing model 150.

In some embodiments, output of the supervised natural language processing model 150 may be provided as input to the large language model 160 or another large language model to further improve quality and/or refine the data of the one or more classification data objects 508.

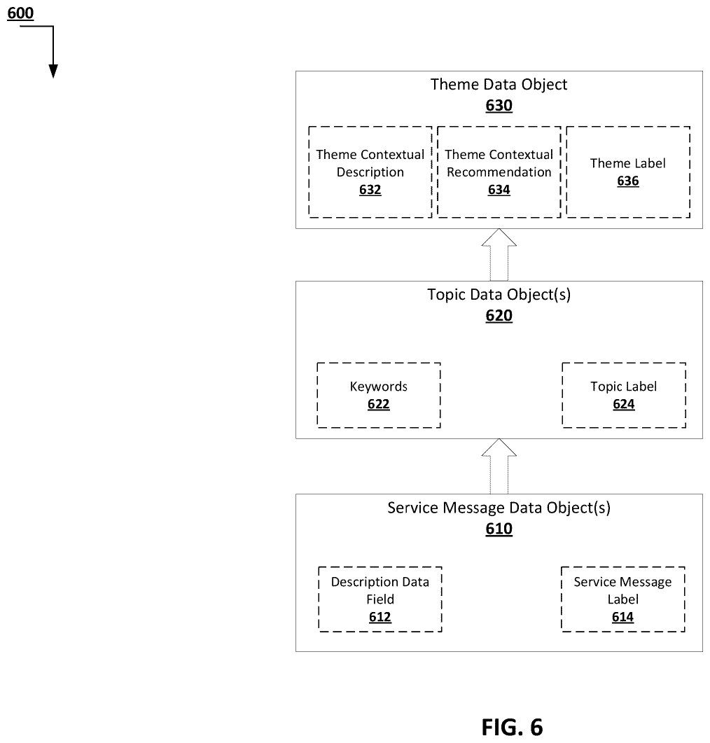

Referring to FIG. 6, an example representational hierarchy 600 is presented in accordance with one or more embodiments of the present disclosure. The representational hierarchy 600 depicts various data objects of the present disclosure, including a service message data objects 610, a topic data objects 620, and/or a theme data objects 630.

In some embodiments, the service message data object 610 may be considered a representation of a service request associated with an application framework (e.g., application framework 106) that is a lower-order representation than the topic data object 620 and/or a theme data object 630. For example, a user of an application framework system submitting the service request may generate or otherwise cause generation of a service message data object 610. In this manner, the service message data object 610 may most directly represent the service request. For example, the description data field 612 of the service message data object 610 may include a textual description of the service request written by the user, a service agent, and/or the like, to describe the service request in detail. The service message label 614 may be, for example, a term or phrase that labels the service request. In some embodiments, one or more service message data objects 610 may be used to generate one or more higher-order representations of service requests associated with an application framework system.

In some embodiments, the topic data object 620 may be considered a representation of a service request associated with an application framework system that is a higher-order representation than a service message data object 610 and a lower-order representation than the theme data object 630. For example, the topic data object 620 may be generated based on one or more service message data objects 610 via an unsupervised natural language processing model applied to a feature set including data extracted from the one or more service message data objects 610. In some embodiments, the topic data object 620 may include one or more keywords 622 and/or a topic label 624 descriptive of a topic identified from one or more service message data objects 610. In this manner, the topic data object 620 may be representative of the one or more service message data objects 610 and, by extension, one or more service requests associated with an application framework. In some embodiments, one or more topic data objects 620 may be used to generate one or more higher-order representations of service requests associated with an application framework.

In some embodiments, the theme data object 630 may be considered a representation of a service request associated with an application framework that is a higher-order representation than the topic data object 620 and/or a service message data object 610. For example, the theme data object 630 may be generated based on one or more topic data objects 620 and/or one or more service message data objects 610 via a large language model applied to a feature set including data extracted from the one or more topic data objects 620 and/or the one or more service message data objects 610. In some embodiments, the theme data object 630 may include a theme contextual description 632, a theme contextual recommendation 634, and/or a theme label 636 representative of a theme identified from the one or more topic data object 620 and/or the one or more service message data objects 630. In this manner, the theme data object 630 may be representative of the one or more topic data objects 620 and/or the one or more service message data objects 610 and, by extension, one or more service requests associated with an application framework.

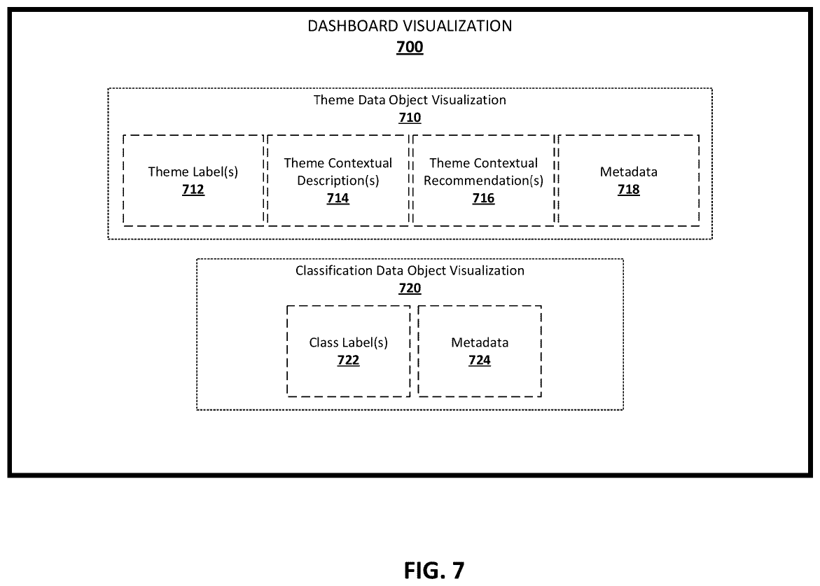

Referring to FIG. 7, an example dashboard visualization 700 is presented in accordance with one or more embodiments of the present disclosure. As shown, the dashboard visualization 700 includes the theme data object visualization 710, and the classification data object visualization 720. In some embodiments, the dashboard visualization 700 may be generated based on one or more service message data objects, one or more topic data objects, one or more theme data objects, and/or one or more classification data objects. In some embodiments, the theme data object visualization 710 may be generated based on one or more theme data objects. For example, the theme data object visualization 710 may be an interface module of the dashboard visualization 700 configured to display a predetermined format for displaying data based on one or more theme data objects. In some embodiments, the classification data object visualization 720 may be generated based on one or more classification data objects. For example, the classification data object visualization 720 may be an interface module of the dashboard visualization 700 configured to display a predetermined format for displaying data based on one or more classification data objects.

In some embodiments, the theme data object visualization 710 may display the text or a portion thereof of one or more data fields of one or more theme data objects. For example, the theme data object visualization 710 may display one or more theme labels 712, theme contextual descriptions 714, theme contextual recommendations 716, and/or the like. In one example, the theme data object visualization 710 may display the one or more theme labels 712 and metadata 718 descriptive of the number of service message data objects associated with each theme label of the one or more theme labels 712. Additionally or alternatively, the theme data object visualization 710 may display the one or more theme labels 712 and metadata 718 descriptive of the number of service message data objects associated with each theme label of the one or more theme labels 712 for a given time interval (e.g., last three weeks), one or more time intervals (e.g., the same three months across the last four years), and/or the like. Additionally or alternatively, the theme data object visualization 710 may display a theme contextual description 714 and/or one or more theme contextual recommendations 716 for each theme label of the one or more theme labels 712. Additionally or alternatively, the theme data object visualization 710 may display one or more theme contextual recommendations 716 in a sorted order, for example, a sorted order by how many service message data objects are associated with each theme contextual recommendation 716. Additionally or alternatively, the theme data object visualization 710 may display one or more data visualizations such as, for example, a bar graph, line graph, pie graph, and/or the like where the one or more data visualizations display the one or more theme labels 712 and metadata 718 descriptive of the number of service message data objects associated with each respective theme label 712. In various embodiments, the theme data object visualization 710 may be rendered and/or interacted with via a specially configured API associated with the application framework system 105. In various embodiments, the theme data object visualization 710 may be rendered via a specially configured dashboard interface to provide users with interactive access to the one or more theme labels 712, the theme contextual descriptions 714, the theme contextual recommendations 716, and/or the like. In various embodiments, a self-serve interface tool may be utilized to encapsulate an underlying workflow for the theme data object visualization 710 to allow users to explore and/or analyze the one or more theme labels 712, the theme contextual descriptions 714, the theme contextual recommendations 716, and/or the like via the dashboard visualization 700.

In some embodiments, the classification data object visualization 720 may display the text or a portion thereof of one or more data fields of one or more classification data objects. For example, the classification data object visualization 720 may display one or more class labels 722 and/or metadata 724 associated with one or more classification data objects. In one example, the classification data object visualization 720 may display the one or more class labels 722 and metadata 724 descriptive of the number of service message data objects associated with each class label of the one or more class labels 722. Additionally or alternatively, the classification data object visualization 720 may display the one or more class labels 722 and metadata 724 descriptive of the number of service message data objects associated with each class label of the one or more class labels 722 for a given time interval (e.g., last three weeks), one or more time intervals (e.g., the same three months across the last four years), and/or the like. Additionally or alternatively, the classification data object visualization 720 may display one or more class labels 722 in a sorted order, for example, a sorted order by how many service message data objects are associated with each class label of the one or more class labels 722. Additionally or alternatively, the classification data object visualization 720 may display one or more data visualizations such as, for example, a bar graph, line graph, pie graph, and/or the like where the one or more data visualizations display the one or more class labels 722 and metadata 724 descriptive of the number of service message data objects associated with each respective class label 722. In various embodiments, the classification data object visualization 720 may be rendered and/or interacted with via a specially configured API. For example, the classification data object visualization 720 may be rendered and/or interacted with via a RESTful API associated with the application framework system 105.

In various embodiments, the API associated with the classification data object visualization 720 may enable real-time identification and/or categorization of contact reasons or other classifications associated with service message data objects. In various embodiments, the classification data object visualization 720 may be rendered via a specially configured dashboard interface to provide users with interactive access to the one or more class labels 722 and/or the metadata 724 associated with one or more classification data objects.

In some embodiments, the theme data object visualization 710 and the classification data object visualization 720 may be coupled such that the theme data object visualization 710 may display visualizations and/or data from the classification data object visualization 720. For example, a theme data object visualization 710 that displays one or more theme labels 712 may further display the one or more class labels 722, metadata 718 descriptive of the number of service message data objects associated with each theme label 712, and/or metadata 724 descriptive of the number of service message data objects associated with each class label of the one or more class labels 722. Additionally or alternatively, the theme data object visualization 710 and the classification data object visualization 720 may be coupled such that the classification data object visualization 720 may display visualizations and/or data from the theme data object visualization 710. For example, a classification data object visualization 720 that displays the one or more class labels 722 may further display one or more theme labels 712, metadata 718 descriptive of the number of service message data objects associated with each theme label 712, and/or metadata 724 descriptive of the number of service message data objects associated with each class label of the one or more class labels 722.

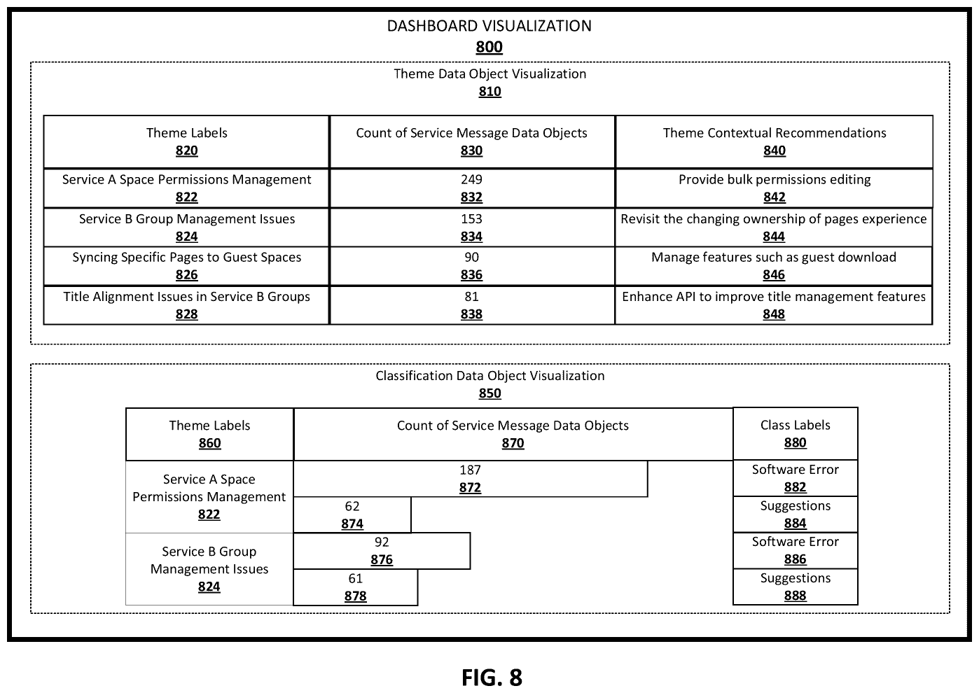

Referring to FIG. 8, a non-limiting example dashboard visualization 800 is presented in accordance with one or more embodiments of the present disclosure. As shown, the dashboard visualization 800 includes the theme data object visualization 810 and the classification data object visualization 850. The theme data object visualization 810 may be based on one or more theme data objects. For example, the theme data object visualization 810 is a table configured to display the theme labels 820, the count of service message data objects 830, and the theme contextual recommendations from one or more theme data objects. The theme labels 820 include four theme labels 822-828, the count of service message data objects 830 includes metadata 832-838 descriptive of the number of service message data objects associated with each theme label 822-828, and the theme contextual recommendations 840 includes theme contextual recommendations 842-848 associated with each theme label 822-828. For simplicity, the theme contextual descriptions are now shown. However, it should be appreciated that the theme contextual descriptions may be included the dashboard visualization of various embodiments of the present disclosure. Additionally, it is to be appreciated that, in certain embodiments, the theme labels 822-828 may include a different number of labels.

The classification data object visualization 850 may be based on one or more classification data objects and one or more theme data objects. For example, the classification data object visualization 850 is a table configured to display the theme labels 860 associated with one or more theme data objects, the count of service message data objects 870, and the class labels 880 associated with one or more classification data objects. The theme labels 860 include two theme labels 822-824 associated with one or more theme data objects. The count of service message data objects 870 includes metadata 872-878 descriptive of the number of service message data objects associated with each of the class labels 880 and formatted as a bar graph. The class labels 880 include four class labels 882-888 associated with one or more classification data objects. Additionally, it is to be appreciated that, in certain embodiments, the theme labels 822-824 may include a different number of labels.

Via the theme labels 820, the dashboard visualization 800 provides easily accessible insights into various themes associated with a plurality of service message data objects of an application framework (e.g., application framework 106). Via the count of service message data objects 830, the dashboard visualization 800 provides quick and simple insights into the number of service message data objects associated with each of the theme labels 820. Via the theme contextual recommendations 840, the dashboard visualization 800 provides actionable recommendations for resolving and/or addressing the service requests associated with an application framework. Via the count of service message data objects 870 and the class labels 880, the dashboard visualization 800 provides a bar graph that provides an insight into how many service message data objects associated with a theme label 822-824 report a software error or a suggestion. In this manner, the dashboard visualization 800 may allow administrators or other personnel associated with an application framework to prioritize service requests, quickly understand the volumes of service requests users associated with the application framework raise, identify solutions to such service requests, manage resources of an application framework, and/or the like. Notably, the dashboard visualization 800 does not require extensive domain knowledge or technical expertise to understand or gather insights from and may be programmatically generated.

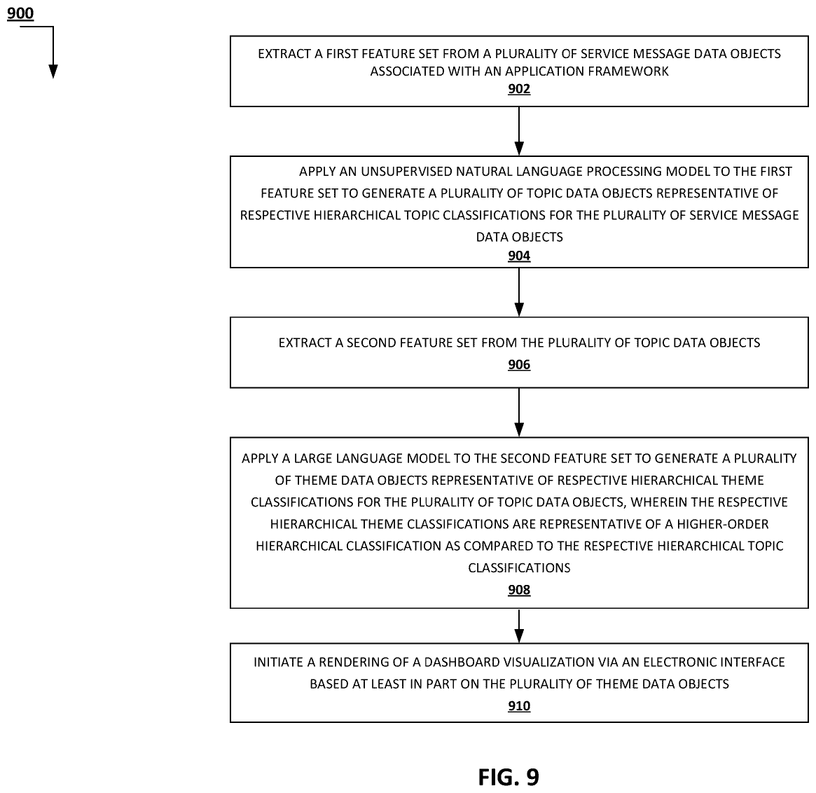

FIG. 9 is a flowchart diagram of an example process 900 for generating a dashboard visualization based on one or more theme data objects in accordance with, for example, the service message insights apparatus 120. Via the various operations of process 900, the service message insights apparatus 120 may enhance performance of the application framework 106 and/or the one or more machine learning models 130.

The process 900 begins at operation 902 where a first feature set is extracted from a plurality of service message data objects associated with an application framework. The process 900 additionally or alternatively includes an operation 904 that applies an unsupervised natural language processing model to the first feature set to generate a plurality of topic data object representative of a respective hierarchical topic classifications for the plurality of service message data objects. The process additionally or alternatively includes an operation 906 that extracts a second feature set from the plurality of topic data objects. The process 900 additionally or alternatively includes an operation 908 that applied a large language model to the second feature set to generate a plurality of theme data objects representative of a respective hierarchical theme classification for the topic data objects, where the respective hierarchical theme classifications are representative of a higher-order hierarchical classification as compared to the respective hierarchical topic classifications. The process 900 additionally or alternatively includes an operation 910 that initiates a rendering of a dashboard visualization via an electronic interface based at least in part on the plurality of theme data objects.

In some embodiments, the unsupervised natural language processing model includes an unsupervised machine learning embedding model. Additionally, in some embodiments, the process 900 additionally or alternatively includes an operation that applies the unsupervised machine learning embedding model to the first feature set to generate a plurality of embeddings representative of the first feature set.

In some embodiments, the unsupervised natural language processing model additionally or alternatively includes a dimensionality reduction technique. Additionally, in some embodiments, the process 900 additionally or alternatively includes an operation that applies the dimensionality reduction technique to the plurality of embeddings to generate a lower dimensional representation of the plurality of embeddings.

In some embodiments, the unsupervised natural language processing model additionally or alternatively includes a spatial clustering technique. Additionally, in some embodiments, the process 900 additionally or alternatively includes an operation that applies the spatial clustering technique to the lower dimensional representation of a plurality of embeddings to generate a plurality of cluster data objects.

In some embodiments, the unsupervised natural language processing model additionally or alternatively includes a class-based weighted term technique. Additionally, in some embodiments, the process 900 additionally or alternatively includes an operation that applies the class-based weighted term technique to the plurality of cluster data objects to generate a rank score for each keyword of a plurality of keywords. In some embodiments, the plurality of keywords is associated with a cluster data object of the plurality of cluster data objects. In some embodiments, the rank score is indicative of the importance of a respective keyword.

In some embodiments, the large language model includes an autoregressive large language model configured to generate a textual output based on a textual input.

In some embodiments, respective service message data objects of the plurality of service message data objects include at least a description data field associated with a service request by a user identifier. Additionally, in some embodiments, the process 900 additionally or alternatively includes an operation that extracts the first feature set from the plurality of service message data objects by extracting the description data field from the respective service message data objects.

In some embodiments, the plurality of topic data objects includes a plurality of keywords. Additionally, in some embodiments, the process 900 additionally or alternatively includes an operation that extracts the second feature set from the plurality of topic data objects by extracting the plurality of keywords from the plurality of topic data objects.

In some embodiments, the process 900 additionally or alternatively includes an operation that generates, based at least in part one or more service message data objects associated with a topic data object, a theme contextual description that is descriptive of the one or more service message data objects associated with the topic data object. In some embodiments, each of the plurality of theme data objects includes a respective theme contextual description.

In some embodiments, the process 900 additionally or alternatively includes an operation that generates, based at least in part on one or more service message data objects associated with a topic data object, a theme contextual recommendation that is representative of at least one actionable recommendation. In some embodiments, each of the plurality of theme data objects additionally or alternatively includes a respective theme contextual recommendation.

In some embodiments, the dashboard visualization includes one or more interface modules respectively configured to display a predetermined format for displaying data based on the plurality of theme data objects.

In some embodiments, the large language model is a first large language model. Additionally, in some embodiments, the process 900 additionally or alternatively includes an operation that generates at least a portion of the first feature set based at least in part on a second large language model.

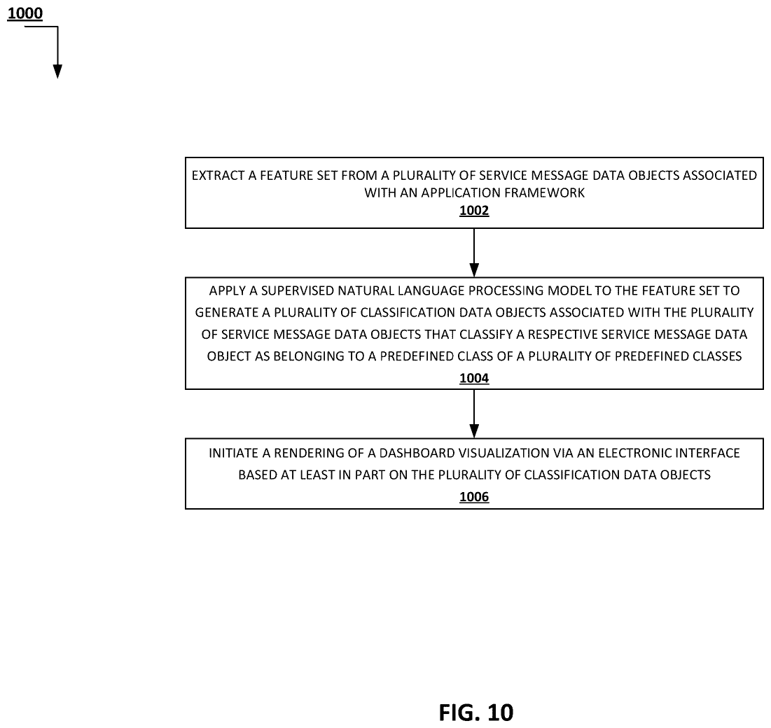

FIG. 10 is a flowchart diagram of an example process 1000 for generating a dashboard visualization based on one or more classification data objects in accordance with, for example, the service message insights apparatus 120. Via the various operations of process 1000, the service message insights apparatus 120 may enhance performance of the application framework 106 and/or the one or more machine learning models 130.

The process 1000 begins at operation 1002 where a feature set is extracted from a plurality of service message data objects associated with an application framework. The process 1000 additionally or alternatively includes an operation 1004 that applies a supervised natural language processing model to the feature set to generate a plurality of classification data objects associated with the plurality of service message data objects that classify a respective service message data object as belonging to a predefined class of a plurality of predefined classes. The process 1000 additionally or alternatively includes an operation 1006 that initiates a rendering of a dashboard visualization via an electronic interface based at least in part on the plurality of classification data objects.

In some embodiments, the plurality of service message data objects respectively includes at least a description data field associated with a service request by a user identifier. Additionally, in some embodiments, the process 1000 additionally or alternatively includes an operation that extracts the feature set from the plurality of service message data objects by extracting the description data field from the respective service message data objects.

In some embodiments, the predefined class is representative of a reason for making a service request.

In some embodiments, the dashboard visualization includes at least one module. Additionally, the at least one module may be configured to display a predetermined format for displaying data based on the plurality of classification data objects.

In some embodiments, the dashboard visualization includes a module configured to display a proportion of service message data objects associated with a respective classification.

In some embodiments, the process 1000 additionally or alternatively includes an operation that evaluates performance of the supervised natural language processing model using one or more performance metrics at a predetermined time interval. In some embodiments, the process 1000 additionally or alternatively includes an operation that adjusts one or more parameters of the supervised natural language processing model based on the one or more performance metrics.

In some embodiments, the supervised natural language processing model is a bidirectional transformer model that is fine-tuned for multi-class text classification.

In some embodiments, the process 1000 additionally or alternatively includes an operation that generates at least a portion of the feature set based at least in part on a large language model.

Although example processing systems have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, e.g., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

The operations described herein may be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus may include special purpose logic circuitry, e.g., an FPGA (field programmable gate array) or an ASIC (Application Specific Integrated Circuit). The apparatus may also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment may realize various different computing model infrastructures, such as web components, web services, web microservices, distributed computing and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments of the subject matter described herein may be implemented on a computer having a display device, e.g., a CRT (cathode ray tube) or LCD (liquid crystal display) monitor, for displaying information/data to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's query-initiating computing device in response to requests received from the web browser.

Embodiments of the subject matter described herein may be implemented in a computing system that includes a back-end component, e.g., as an information/data server, or that includes a middleware component, e.g., an application server, or that includes a front-end component, e.g., a query-initiating computing device having a graphical user interface or a web browser through which a user may interact with an implementation of the subject matter described herein, or any combination of one or more such back-end, middleware, or front-end components. The components of the system may be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system may include clients and servers. A client and server are generally remote from each other and typically interact through a communication network. The relationship of client and server arises by virtue of computer programs running on the respective computers and having a client-server relationship to each other. In some embodiments, a server transmits information/data (e.g., a Hypertext Markup Language (HTML) page) to a query-initiating computing device (e.g., for purposes of displaying information/data to and receiving user input from a user interacting with the query-initiating computing device). Information/data generated at the query-initiating computing device (e.g., a result of the user interaction) may be received from the query-initiating computing device at the server.

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. An apparatus comprising one or more processors and one or more storage devices storing instructions that are operable, when executed by the one or more processors, to cause the one or more processors to:
apply a first large language model to a plurality of service message data objects associated with an application framework to generate a first feature set for the plurality of service message data objects;
generate, based on the first feature set, a plurality of topic data objects representative of respective hierarchical topic classifications for the plurality of service message data objects;
extract a second feature set from the plurality of topic data objects;
apply a second large language model to the second feature set to generate a plurality of theme data objects representative of respective hierarchical theme classifications for the plurality of topic data objects, wherein the respective hierarchical theme classifications are representative of a higher-order hierarchical classification as compared to the respective hierarchical topic classifications; and
initiate a rendering of a dashboard visualization via an electronic interface based at least in part on the plurality of theme data objects.

2. The apparatus of claim 1, wherein the one or more storage devices store instructions that are operable, when executed by the one or more processors, to further cause the one or more processors to:
apply an unsupervised natural language processing model to the first feature set to generate the plurality of topic data objects.

3. The apparatus of claim 1, wherein the one or more storage devices store instructions that are operable, when executed by the one or more processors, to further cause the one or more processors to:
apply a machine learning embedding model to the first feature set to generate the plurality of topic data objects.

4. The apparatus of claim 1, wherein the one or more storage devices store instructions that are operable, when executed by the one or more processors, to further cause the one or more processors to:
apply a dimensionality reduction technique to a plurality of embeddings associated with the first feature set to generate the plurality of topic data objects.

5. The apparatus of claim 1, wherein the one or more storage devices store instructions that are operable, when executed by the one or more processors, to further cause the one or more processors to:
apply a spatial clustering technique to a plurality of embeddings associated with the first feature set to generate a plurality of cluster data objects;
apply a class-based weighted term technique to the plurality of cluster data objects to generate a rank score for each keyword of a plurality of keywords, wherein the plurality of keywords is associated with a cluster data object of the plurality of cluster data objects, and wherein the rank score is indicative of a respective importance of a respective keyword; and
generate the plurality of topic data objects based on the rank score for each keyword of the plurality of keywords.

6. The apparatus of claim 1, wherein the second large language model comprises an autoregressive large language model configured to generate a textual output based on a textual input.

7. The apparatus of claim 1, wherein respective service message data objects of the plurality of service message data objects comprises at least a description data field associated with a service request by a user identifier, and wherein the one or more storage devices store instructions are operable, when executed by the one or more processors, to further cause the one or more processors to:
extract the first feature set from the plurality of service message data objects by extracting the description data field from the respective service message data objects.

8. The apparatus of claim 1, wherein the plurality of topic data objects comprises a plurality of keywords, and wherein the one or more storage devices store instructions are operable, when executed by the one or more processors, to further cause the one or more processors to:
extract the second feature set from the plurality of topic data objects by extracting the plurality of keywords from the plurality of topic data objects.

9. The apparatus of claim 1, wherein the dashboard visualization comprises one or more interface modules respectively configured to display a predetermined format for displaying data based on the plurality of theme data objects.

10. A computer-implemented method, comprising:
applying a first large language model to a plurality of service message data objects associated with an application framework to generate a first feature set for the plurality of service message data objects;
generating, based on the first feature set, a plurality of topic data objects representative of respective hierarchical topic classifications for the plurality of service message data objects;
extracting a second feature set from the plurality of topic data objects;
applying a second large language model to the second feature set to generate a plurality of theme data objects representative of respective hierarchical theme classifications for the plurality of topic data objects, wherein the respective hierarchical theme classifications are representative of a higher-order hierarchical classification as compared to the respective hierarchical topic classifications; and
initiating a rendering of a dashboard visualization via an electronic interface based at least in part on the plurality of theme data objects.

11. The computer-implemented method of claim 10, wherein generating the plurality of topic data objects comprises:
applying an unsupervised natural language processing model to the first feature set to generate the plurality of topic data objects.

12. The computer-implemented method of claim 10, wherein generating the plurality of topic data objects comprises:
applying a machine learning embedding model to the first feature set to generate the plurality of topic data objects.

13. The computer-implemented method of claim 10, wherein generating the plurality of topic data objects comprises:
applying a dimensionality reduction technique to a plurality of embeddings associated with the first feature set to generate the plurality of topic data objects.

14. The computer-implemented method of claim 10, further comprising:
applying a spatial clustering technique to a plurality of embeddings associated with the first feature set to generate a plurality of cluster data objects;
applying a class-based weighted term technique to the plurality of cluster data objects to generate a rank score for each keyword of a plurality of keywords, wherein the plurality of keywords is associated with a cluster data object of the plurality of cluster data objects, and wherein the rank score is indicative of a respective importance of a respective keyword; and
generating the plurality of topic data objects based on the rank score for each keyword of the plurality of keywords.

15. The computer-implemented method of claim 10, wherein the second large language model comprises an autoregressive large language model configured to generate a textual output based on a textual input.

16. The computer-implemented method of claim 10, wherein respective service message data objects of the plurality of service message data objects comprises at least a description data field associated with a service request by a user identifier, and the computer-implemented method further comprising:
extracting the first feature set from the plurality of service message data objects by extracting the description data field from the respective service message data objects.

17. The computer-implemented method of claim 10, wherein the plurality of topic data objects comprises a plurality of keywords, and the computer-implemented method further comprising:
extracting the second feature set from the plurality of topic data objects by extracting the plurality of keywords from the plurality of topic data objects.

18. A computer program product comprising at least one non-transitory computer readable storage medium having computer executable code portions stored therein, the computer executable code portions comprising program code instructions configured to:
apply a first large language model to a plurality of service message data objects associated with an application framework to generate a first feature set for the plurality of service message data objects;
generate, based on the first feature set, a plurality of topic data objects representative of respective hierarchical topic classifications for the plurality of service message data objects;
extract a second feature set from the plurality of topic data objects;
apply a second large language model to the second feature set to generate a plurality of theme data objects representative of respective hierarchical theme classifications for the plurality of topic data objects, wherein the respective hierarchical theme classifications are representative of a higher-order hierarchical classification as compared to the respective hierarchical topic classifications; and
initiate a rendering of a dashboard visualization via an electronic interface based at least in part on the plurality of theme data objects.

19. The computer program product of claim 18, the computer program product further comprising instructions that when executed by the one or more computers cause the one or more computers to:
apply an unsupervised natural language processing model to the first feature set to generate the plurality of topic data objects.

20. The computer program product of claim 18, the computer program product further comprising instructions that when executed by the one or more computers cause the one or more computers to:
apply a machine learning embedding model to the first feature set to generate the plurality of topic data objects.
